(19) United States
(12) Patent Application Publication
(10) Pub. No.: US 2025/0264700 A1
(43) Pub. Date: Aug. 21, 2025

(54) PROJECTION OPTICAL SYSTEM AND PROJECTION TYPE DISPLAY DEVICE

(71) Applicant: FUJIFILM Corporation, Tokyo (JP)

(72) Inventors: Yukiko NAGATOSHI, Saitama (JP); Masaru AMANO, Saitama (JP)

(73) Assignee: FUJIFILM Corporation, Tokyo (JP)

(21) Appl. No.: 19/023,164

(22) Filed: Jan. 15, 2025

(30) Foreign Application Priority Data
Feb. 16, 2024 (JP) 2024-022208
Sep. 20, 2024 (JP) 2024-163806

(51) Int. Cl. G02B 13/16; G02B 9/64; G02B 13/18

(52) U.S. Cl. CPC G02B 13/16; G02B 9/64; G02B 13/18

(57) ABSTRACT

Provided is a projection optical system that projects an image on a reduction-side imaging plane onto an enlargement-side imaging plane, a half angle of view on an enlargement side is 50 degrees or more, in a case where one lens component is one single lens or one cemented lens, the projection optical system includes a P lens component that is a lens component having a positive power and closest to the enlargement side among lens components in the projection optical system and an N lens component that is a lens component having a negative power and disposed adjacent to the enlargement side of the P lens component, and predetermined conditional expressions are satisfied.

### CROSS-REFERENCE TO RELATED APPLICATIONS

This application claims priority from Japanese Patent Application No. 2024-022208, filed on Feb. 16, 2024, and Japanese Patent Application No. 2024-163806, filed on Sep. 20, 2024. Each application above is hereby expressly incorporated by reference, in its entirety, into the present application.

### BACKGROUND

### Technical Field

The present disclosed technology relates to a projection optical system and a projection type display device.

### Related Art

Optical systems described in WO2017/195857A and WO2020/110380A below have been known as optical systems applicable to the projection type display device.

### SUMMARY

A projection optical system where a reduction in size is achieved and satisfactory optical performance is maintained while having a wide angle of view and a long back focus has been demanded. A level of the demand has increased year by year.

The present disclosure has been made in view of the above circumstances, and provides a projection optical system where a reduction in size is achieved and satisfactory optical performance is maintained while having a wide angle of view and a long back focus, and a projection type display device including this projection optical system.

According to a first aspect of the present disclosure, there is provided a projection optical system that projects an image on a reduction-side imaging plane onto an enlargement-side imaging plane, a half angle of view on an enlargement side is 50 degrees or more, in a case where one lens component is one single lens or one cemented lens, the projection optical system includes a P lens component that is a lens component having a positive power and closest to the enlargement side among lens components in the projection optical system and an N lens component that is a lens component having a negative power and disposed adjacent to the enlargement side of the P lens component, and
Conditional Expressions (1), (2), (3), (4), and (5) represented by

$$\begin{matrix}1 < Zp / Y max < 4 , & ( 1 ) \\ 0.2 < Rpf / Y max < 2.3 , & ( 2 ) \\ 0.2 < Rnr / Y max < 5 , & ( 3 ) \\ 2 < Bf / Y max < 8 , and & ( 4 ) \\ 0.35 < Y 50 / Y 40 < 1.5 & ( 5 )\end{matrix}$$

are satisfied.

Here, a maximum image height on the reduction-side imaging plane is represented by Ymax. A distance on an optical axis from a surface of an optical element having a power closest to the enlargement side in the projection optical system to a lens surface closest to the enlargement side in the P lens component is represented by Zp. A curvature radius of the lens surface closest to the enlargement side in the P lens component is represented by Rpf. A curvature radius of a lens surface closest to the reduction side in the N lens component is represented by Rnr. A back focus of the projection optical system on the reduction side in terms of an air conversion distance is represented by Bf. An image height on the reduction-side imaging plane of a ray having a half angle of view of 40 degrees on the enlargement side is represented by Y40. An image height on the reduction-side imaging plane of a ray having a half angle of view of 50 degrees on the enlargement side is represented by Y50. Ymax, Zp, Bf, Y40, and Y50 are values at a wide-angle end in a case where the projection optical system is a variable magnification optical system.

According to a second aspect of the present disclosure, the projection optical system according to the first aspect consists of a first optical system and a second optical system along an optical path in order from the enlargement side to the reduction side, in which the second optical system forms an intermediate image at a position conjugate to the reduction-side imaging plane between the first optical system and the second optical system, and the first optical system re-forms the intermediate image on the enlargement-side imaging plane.

According to a third aspect of the present disclosure, in the projection optical system according to the first aspect, in a case where a spacing on the optical axis between the N lens component and the P lens component is represented by Dnp, and Dnp is a value at the wide-angle end in a case where the projection optical system is a variable magnification optical system,
Conditional Expression (6) represented by

$$0 < Dnp / Y max < 0.1 \qquad ( 6 )$$

is satisfied.

According to a fourth aspect of the present disclosure, in the projection optical system according to the first aspect, in a case where a curvature radius of a lens surface closest to the reduction side in the P lens component is represented by Rpr,
Conditional Expression (7) represented by

$$0 < ( Rpr + Rpf ) / ( Rpr - Rpf ) < 2 \qquad ( 7 )$$

is satisfied.

According to a fifth aspect of the present disclosure, in the projection optical system according to the first aspect, in a case where a larger value among a maximum effective diameter of the lens surface closest to the enlargement side in the P lens component and a maximum effective diameter of the lens surface closest to the reduction side in the P lens component is represented by EDp,
Conditional Expression (8) represented by

$$0.5 < EDp / Y max < 2.5 \qquad ( 8 )$$

is satisfied.

According to a sixth aspect of the present disclosure, in the projection optical system according to the first aspect, in a case where a curvature radius of a lens surface closest to the enlargement side in the N lens component is represented by Rnf,
Conditional Expression (9) represented by

$$- 1 < ( Rnr + Rnf ) / ( Rnr - Rnf ) < 0.5 \qquad ( 9 )$$

is satisfied.

According to a seventh aspect of the present disclosure, in the projection optical system according to the second aspect, the projection optical system is a zoom lens including movable lens groups that move during changing magnification in the second optical system,
Conditional Expression (10) represented by

$$0.2 < dA max / Y max < 2.5 \qquad ( 10 )$$

is satisfied.

Here, a group consisting of all of lenses closer to the enlargement side than the movable lens group closest to the enlargement side among the movable lens groups in the projection optical system is an enlargement-side stationary group. A longest air spacing between lens surfaces on the optical axis in the enlargement-side stationary group at the wide-angle end is represented by dAmax.

According to an eighth aspect of the present disclosure, in the projection optical system according to the second aspect, the projection optical system is a zoom lens, the second optical system consists of a second A lens group, a second B lens group, a second C lens group, and a second D lens group along the optical path in order from the enlargement side to the reduction side, and during changing magnification, the second A lens group and the second D lens group are fixed to the reduction-side imaging plane, and the second B lens group and the second C lens group move while changing a mutual spacing. Here, one lens group is a group of which a spacing to an adjacent group in an optical axis direction changes during changing magnification in the second optical system.

According to a ninth aspect of the present disclosure, in the projection optical system according to the eighth aspect, in a case where a focal length of the second B lens group is represented by f2B, and a focal length of the second C lens group is represented by f2C,
Conditional Expression (11) represented by

$$0 < f 2 B / \vert f 2 C \vert < 0.5 \qquad ( 11 )$$

is satisfied.

According to a tenth aspect of the present disclosure, in the projection optical system according to the first aspect, in a case where a larger value among a maximum effective diameter of an enlargement-side surface of a lens closest to the enlargement side in the projection optical system and a maximum effective diameter of a reduction-side surface of the lens closest to the enlargement side in the projection optical system is represented by EDL1, and a specific gravity of the lens closest to the enlargement side in the projection optical system is represented by pL1,
Conditional Expression (12) represented by

$$0.5 < EDL 1 \times ρ L 1 / Y max < 10 \qquad ( 12 )$$

is satisfied.

According to an eleventh aspect of the present disclosure, in the projection optical system according to the first aspect, the P lens component is a single lens, and a refractive index of the P lens component with respect to a d line is 1.65 or more.

According to a twelfth aspect of the present disclosure, in the projection optical system according to the eleventh aspect, the N lens component is a single lens, and a refractive index of the N lens component with respect to the d line is 1.65 or less.

According to a thirteenth aspect of the present disclosure, in the projection optical system according to the second aspect, the first optical system includes an aspherical lens.

According to a fourteenth aspect of the present disclosure, in the projection optical system according to the thirteenth aspect, the first optical system includes two aspherical lenses.

According to a fifteenth aspect of the present disclosure, in the projection optical system according to the thirteenth aspect, a lens surface closest to the enlargement side in the first optical system is an aspherical surface that has a concave surface facing the enlargement side in a paraxial region and has an inflection point where an uneven shape changes halfway from the optical axis toward a peripheral portion.

According to a sixteenth aspect of the present disclosure, in the projection optical system according to the second aspect, the reduction side is telecentric.

According to a seventeenth aspect of the present disclosure, there is provided a projection type display device comprising: the projection optical system according to any one of the first to sixteenth aspects.

According to an eighteenth aspect of the present disclosure, there is provided a projection optical system consisting of a first optical system and a second optical system along an optical path in order from an enlargement side to a reduction side, in which the second optical system forms an intermediate image at a position conjugate to a reduction-side imaging plane between the first optical system and the second optical system, and the first optical system re-forms the intermediate image on an enlargement-side imaging plane, a focus group that includes six or more lenses and performs focus adjustment of an entire image plane in a case where a projection distance changes by moving along the optical axis is disposed closest to the enlargement side in the projection optical system, and all of lens spacings in the focus group are invariable during the focus adjustment.

According to a nineteenth aspect of the present disclosure, in the projection optical system according to the eighteenth aspect, the focus group is disposed in the first optical system.

According to a twentieth aspect of the present disclosure, in the projection optical system according to the eighteenth aspect,
Conditional Expression (13) represented by

$$0.02 < ( 1 - β {F}^{2} ) \times β {Fr}^{2} < 0.2 \qquad ( 13 )$$

is satisfied.

Here, a paraxial lateral magnification of the focus group is represented by βF. A combined paraxial lateral magnification of all of lenses closer to the reduction side than the focus group is represented by βFr. βF and βFr are values at a wide-angle end in a case where the projection optical system is a variable magnification optical system.

According to a twenty first aspect of the present disclosure, in the projection optical system according to the eighteenth aspect,
Conditional Expression (14) represented by

$$0.1 < ( ( 1 - β {F}^{2} ) \times β {Fr}^{2} ) / Δ tF < 0.5 \qquad ( 14 )$$

is satisfied.

Here, a paraxial lateral magnification of the focus group is represented by βF. A combined paraxial lateral magnification of all of lenses closer to the reduction side than the focus group is represented by βFr. A maximum image height on the reduction-side imaging plane is represented by Ymax. An amount of change in an optical axis direction of a tangential image plane at a half angle of view of 50 degrees during movement of the focus group by 0.1×Ymax in the optical axis direction is represented by ΔtF. βF, βFr, Ymax, and ΔtF are values at a wide-angle end in a case where the projection optical system is a variable magnification optical system.

According to a twenty second aspect of the present disclosure, in the projection optical system according to the eighteenth aspect, the focus group includes two or more positive lenses.

According to a twenty third aspect of the present disclosure, in the projection optical system according to the eighteenth aspect, a lens surface closest to the enlargement side in the focus group is an aspherical surface that has a concave surface facing the enlargement side in a paraxial region and has an inflection point where an uneven shape changes halfway from the optical axis toward a peripheral portion.

According to a twenty fourth aspect of the present disclosure, in the projection optical system according to the eighteenth aspect, among a first lens from the reduction side of the focus group and a second lens from the reduction side of the focus group, one lens is a positive lens and the other lens is a negative lens, and
Conditional Expression (15) represented by

$$0 \leq dFr 12 / Y max < 0. 1 \qquad ( 15 )$$

is satisfied.

Here, a spacing on the optical axis between the first lens from the reduction side of the focus group and the second lens from the reduction side of the focus group is represented by dFr12. A maximum image height on the reduction-side imaging plane is represented by Ymax. Ymax is a value at a wide-angle end in a case where the projection optical system is a variable magnification optical system.

According to a twenty fifth aspect of the present disclosure, in the projection optical system according to the eighteenth aspect, a back focus correction group that performs back focus adjustment by moving along the optical axis is disposed.

According to a twenty sixth aspect of the present disclosure, in the projection optical system according to the eighteenth aspect, the projection optical system is a zoom lens including movable lens groups that move during changing magnification in the second optical system,
Conditional Expression (10) represented by

$$0.2 < d A max / Y max < 2.5 \qquad ( 10 )$$

is satisfied.

Here, a group consisting of all of lenses closer to the enlargement side than the movable lens group closest to the enlargement side among the movable lens groups in the projection optical system is an enlargement-side stationary group. A longest air spacing between lens surfaces on the optical axis in the enlargement-side stationary group at a wide-angle end is represented by dAmax.

According to a twenty seventh aspect of the present disclosure, in the projection optical system according to the eighteenth aspect, the projection optical system is a zoom lens, the second optical system consists of a second A lens group, a second B lens group, a second C lens group, and a second D lens group along the optical path in order from the enlargement side to the reduction side, and during changing magnification, the second A lens group and the second D lens group are fixed to the reduction-side imaging plane, and the second B lens group and the second C lens group move while changing a mutual spacing. Here, one lens group is a group of which a spacing to an adjacent group in an optical axis direction changes during changing magnification in the second optical system.

According to a twenty eighth aspect of the present disclosure, in the projection optical system according to the twenty seventh aspect, in a case where a focal length of the second B lens group is represented by f2B, and a focal length of the second C lens group is represented by f2C,
Conditional Expression (11) represented by

$$0 < f 2 B / \vert f 2 C \vert < 0.5 \qquad ( 11 )$$

is satisfied.

According to a twenty ninth aspect of the present disclosure, there is provided a projection type display device comprising: the projection optical system according to any one of the eighteenth to twenty eighth aspects.

According to a thirtieth aspect of the present disclosure, there is provided a projection optical system consisting of a first optical system and a second optical system, in which the second optical system forms an intermediate image at a position conjugate to a reduction-side imaging plane between the first optical system and the second optical system, and the first optical system re-forms the intermediate image on an enlargement-side imaging plane, a focus group that performs focus adjustment of an entire image plane in a case where a projection distance changes by moving along the optical axis and a back focus correction group that performs back focus adjustment by moving along the optical axis are disposed in the projection optical system, and
Conditional Expression (16) represented by

$$5 < ZFBr / \vert f \vert < 20 \qquad ( 16 )$$

is satisfied.

Here, a distance on the optical axis from a lens surface closest to the enlargement side in the first optical system to a lens surface closest to the reduction side among lens surfaces in the focus group and the back focus correction group is represented by ZFBr. A focal length of the projection optical system is represented by f. ZFBr and f are values at a wide-angle end in a case where the projection optical system is a variable magnification optical system.

According to a thirty first aspect of the present disclosure, in the projection optical system according to the thirtieth aspect,
Conditional Expressions (17) and (18) represented by

$$\begin{matrix}0.02 < ( 1 - β {FF}^{2} ) \times β {FFr}^{2} < 0.2 and & ( 17 ) \\ 0.1 < \vert ( 1 - β {B}^{2} ) \times β B {r}^{2} \vert < 2 & ( 18 )\end{matrix}$$

are satisfied.

Here, a paraxial lateral magnification of the focus group is represented by βFF. A combined paraxial lateral magnification of all of lenses closer to the reduction side than the focus group is represented by βFFr. A paraxial lateral magnification of the back focus correction group is represented by BB. A combined paraxial lateral magnification of all of lenses closer to the reduction side than the back focus correction group is represented by βBr. βFF, βFFr, BB, and βBr are values at the wide-angle end in a case where the projection optical system is a variable magnification optical system.

According to a thirty second aspect of the present disclosure, in the projection optical system according to the thirtieth aspect,
Conditional Expression (19) represented by

$$0.7 < \vert ( 1 - β {B}^{2} ) \times β B {r}^{2} \vert / Δ tB < 1.4 \qquad ( 19 )$$

is satisfied.

Here, a paraxial lateral magnification of the back focus correction group is represented by BB. A combined paraxial lateral magnification of all of lenses closer to the reduction side than the back focus correction group is represented by βBr. A maximum image height on the reduction-side imaging plane is represented by Ymax. An amount of change in an optical axis direction of a tangential image plane at a half angle of view of 50 degrees during movement of the back focus correction group by 0.1×Ymax in the optical axis direction is represented by ΔtB. BB, βBr, Ymax, and ΔtB are values at the wide-angle end in a case where the projection optical system is a variable magnification optical system.

According to a thirty third aspect of the present disclosure, in the projection optical system according to the thirtieth aspect,
Conditional Expression (20) represented by

$$0.1 < ( ( 1 - β {FF}^{2} ) \times β {FFr}^{2} ) / Δ tFF < 0. 5 \qquad ( 20 )$$

is satisfied.

Here, a paraxial lateral magnification of the focus group is represented by βFF. A combined paraxial lateral magnification of all of lenses closer to the reduction side than the focus group is represented by βFFr. A maximum image height on the reduction-side imaging plane is represented by Ymax. An amount of change in an optical axis direction of a tangential image plane at a half angle of view of 50 degrees during movement of the focus group by 0.1×Ymax in the optical axis direction is represented by ΔtFF. βFF, βFFr, Ymax, and ΔtFF are values at the wide-angle end in a case where the projection optical system is a variable magnification optical system.

According to a thirty fourth aspect of the present disclosure, in the projection optical system according to the thirtieth aspect, the focus group and the back focus correction group are movable independently of each other.

According to a thirty fifth aspect of the present disclosure, in the projection optical system according to the thirtieth aspect, the projection optical system is a zoom lens including movable lens groups that move during changing magnification in the second optical system, and
Conditional Expression (10) represented by

$$0.2 < dA max / Y max < 2.5 \qquad ( 10 )$$

is satisfied.

Here, a group consisting of all of lenses closer to the enlargement side than the movable lens group closest to the enlargement side among the movable lens groups in the projection optical system is an enlargement-side stationary group. A longest air spacing between lens surfaces on the optical axis in the enlargement-side stationary group at the wide-angle end is represented by dAmax.

According to a thirty sixth aspect of the present disclosure, in the projection optical system according to the thirtieth aspect, the projection optical system is a zoom lens, the second optical system consists of a second A lens group, a second B lens group, a second C lens group, and a second D lens group along the optical path in order from the enlargement side to the reduction side, and during changing magnification, the second A lens group and the second D lens group are fixed to the reduction-side imaging plane, and the second B lens group and the second C lens group move while changing a mutual spacing. Here, one lens group is a group of which a spacing to an adjacent group in an optical axis direction changes during changing magnification in the second optical system.

According to a thirty seventh aspect of the present disclosure, in the projection optical system according to the thirty sixth aspect, in a case where a focal length of the second B lens group is represented by f2B, and a focal length of the second C lens group is represented by f2C,
Conditional Expression (11) represented by

$$0 < f 2 B / \vert f 2 C \vert < 0.5 \qquad ( 11 )$$

is satisfied.

According to a thirty eighth aspect of the present disclosure, there is provided a projection type display device comprising: the projection optical system according to any one of the thirtieth to thirty seventh aspects.

In the present specification, it should be noted that the terms “consisting of” and “consists of” mean that the lens may include not only the above-described components but also lenses substantially having no (powers) refractive powers, optical elements, which are not lenses, such as a stop, a mask, a filter, a cover glass, a planar mirror, and a prism, and mechanism parts such as a lens flange, a lens barrel, an imaging element, and a camera shaking correction mechanism.

In the present specification, “a group which has a positive power” means that the group has a positive power as a whole, and “a lens component which has a positive power” means that the lens component has a positive power as a whole. Likewise, “a group which has a negative power” means that the group has a negative power as a whole, and “a lens component which has a negative power” means that the lens component has a negative power as a whole. Each of “lens group”, “focus group”, and “back focus correction group” in the present specification is not limited to a configuration consisting of a plurality of lenses, but may have a configuration consisting of only one lens.

A compound aspherical lens (in which a lens (for example, a spherical lens) and an aspherical film formed on the lens are integrally formed and function as one aspherical lens as a whole) is not regarded as a cemented lens, but the compound aspherical lens is regarded as one lens. Regarding a lens having an aspherical surface, a curvature radius, the sign of a power, and a surface shape, those in a paraxial region are used unless otherwise specified. Unless otherwise specified, the “distance on the optical axis” used in Conditional Expression is considered as a geometrical distance. The “focal length” used in a conditional expression is a paraxial focal length. The values used in the conditional expression are values that are obtained with respect to the d line.

The “d line”, “C line”, and “F line” described in the present specification are emission lines, the wavelength of the d line is 587.56 nanometers (nm), the wavelength of the C line is 656.27 nanometers (nm), and the wavelength of the F line is 486.13 nanometers (nm).

According to the present disclosure, it is possible to provide a projection optical system where a reduction in size is achieved and satisfactory optical performance is maintained while having a wide angle of view and a long back focus, and a projection type display device including this projection optical system.

### BRIEF DESCRIPTION OF THE DRAWINGS

FIG. 1 is a cross-sectional view showing a configuration and luminous fluxes of a projection optical system according to an embodiment corresponding to a projection optical system according to Example 1.

FIG. 2 is a diagram for describing symbols of conditional expressions.

FIG. 3 is a partially enlarged view showing the projection optical system of FIG. 1.

FIG. 4 is a diagram for describing a maximum effective diameter.

FIG. 5 is a diagram for describing an amount of change of a tangential image plane.

FIG. 6 shows each of aberration diagrams in the projection optical system according to Example 1.

FIG. 7 is a cross-sectional view showing a configuration and luminous fluxes of a projection optical system according to Example 2.

FIG. 8 shows each of aberration diagrams in the projection optical system according to Example 2.

FIG. 9 is a cross-sectional view showing a configuration and luminous fluxes of a projection optical system according to Example 3.

FIG. 10 shows each of aberration diagrams in the projection optical system according to Example 3.

FIG. 11 is a cross-sectional view showing a configuration and luminous fluxes of a projection optical system according to Example 4.

FIG. 12 shows each of aberration diagrams in the projection optical system according to Example 4.

FIG. 13 is a cross-sectional view showing a configuration and luminous fluxes of a projection optical system according to Example 5.

FIG. 14 shows each of aberration diagrams in the projection optical system according to Example 5.

FIG. 15 is a cross-sectional view showing a configuration and luminous fluxes of a projection optical system according to Example 6.

FIG. 16 shows each of aberration diagrams in the projection optical system according to Example 6.

FIG. 17 is a schematic configuration diagram showing a projection type display device according to an embodiment.

FIG. 18 is a schematic configuration diagram showing a projection type display device according to another embodiment.

FIG. 19 is a schematic configuration diagram showing a projection type display device according to still another embodiment.

### DETAILED DESCRIPTION

Hereinafter, embodiments of the present disclosure will be described with reference to the accompanying drawings.

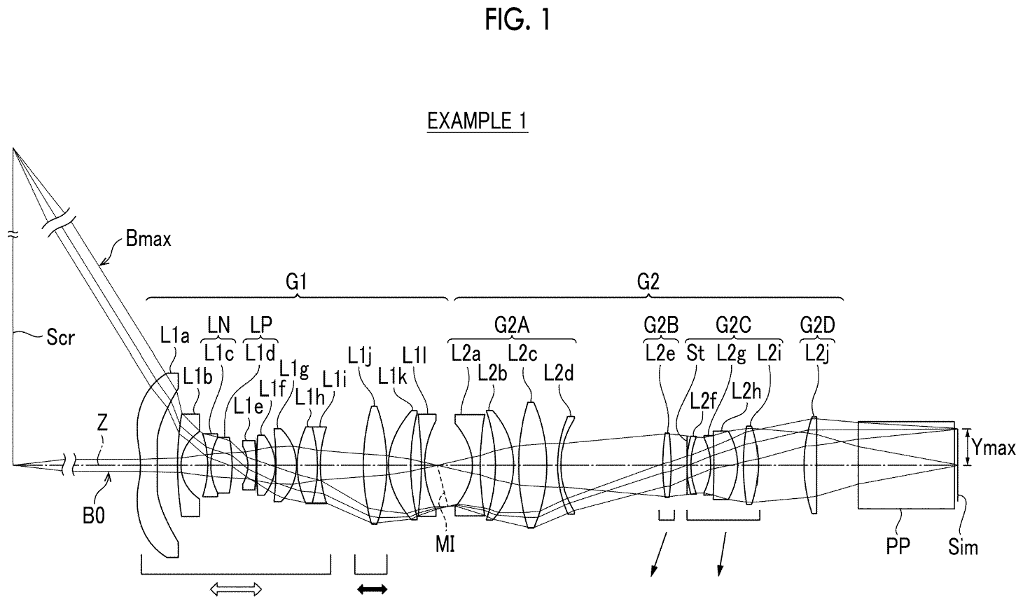

FIG. 1 shows a configuration of a projection optical system and a cross-sectional view of luminous flux according to an embodiment of the present disclosure. FIG. 1 shows, as the luminous fluxes, on-axis luminous fluxes B0 and luminous fluxes Bmax with a maximum half angle of view. In FIG. 1, the left side is an enlargement side, and the right side is a reduction side. The example shown in FIG. 1 corresponds to a projection optical system according to Example 1 described below.

FIG. 1 shows an example in which an optical member PP and a display surface Sim of a light valve are disposed on the reduction side of the projection optical system on the assumption that the projection optical system is mounted on a projection type display device. The light valve is a display element that outputs an optical image, and the optical image is displayed as an image on the display surface Sim. As the light valve, for example, a liquid crystal display element or an image display element such as digital micromirror device (DMD: registered trademark) can be used. The optical member PP is a member which is regarded as a filter, a cover glass, a color synthesis prism, or the like. The optical member PP is a member having no power. The material, the length, and the number of components of the optical member PP can be appropriately changed. A configuration in which the optical member PP is not provided can also be adopted.

The projection optical system can project an image on a reduction-side imaging plane onto an enlargement-side imaging plane. For example, the projection optical system mounted on the projection type display device projects the image displayed on the display surface Sim of the display element onto a screen Scr. Specifically, in the projection type display device, a luminous flux to which image information is given on the display surface Sim of the display element is incident on the projection optical system through the optical member PP, and is projected onto the screen Scr that is a projection surface by the projection optical system. In this case, the display surface Sim corresponds to a reduction-side imaging plane, and the screen Scr corresponds to an enlargement-side imaging plane. The display surface Sim and the screen Scr are positioned at optically conjugate positions. It should be noted that, in the present specification, “screen Scr” refers to an object onto which a projected image formed by the projection optical system is projected. The screen Scr may be not only a dedicated screen but also a wall surface of a room, a floor surface, a ceiling, an outer wall surface of a building, or the like.

In addition, in the description of the present specification, “the enlargement side” refers to the screen Scr side on the optical path, and “the reduction side” refers to the display surface Sim side on the optical path. In the present specification, the “enlargement side” and the “reduction side” are determined along the optical path. Further, the term “adjacent” in the disposition of the components means that the components are adjacent to each other in the arrangement order on the optical path. Hereinafter, in order to avoid redundant description, “along the optical path in order from the enlargement side to the reduction side” will also be referred to as “in order from the enlargement side to the reduction side”.

The projection optical system according to the present disclosure is composed as a wide-angle optical system having a half angle of view of 50 degrees or more on the enlargement side. With this configuration, an image with a wide angle of view can be projected. As a more preferable configuration, the half angle of view on the enlargement side can be set to 55 degrees or more.

For example, the projection optical system of FIG. 1 consists of a first optical system G1 and a second optical system G2 along the optical path in order from the enlargement side to the reduction side. The second optical system G2 forms an intermediate image MI at a position conjugate to the display surface Sim (corresponding to the reduction-side imaging plane) between the first optical system G1 and the second optical system G2. The first optical system G1 re-forms the intermediate image MI on the screen Scr (corresponding to the enlargement-side imaging plane). That is, the projection optical system of FIG. 1 is a relay optical system where the second optical system G2 is a relay group. In a case where the focal length of the projection optical system is shortened to increase the angle of view, in order to achieve optical performance necessary for the projection optical system while ensuring the back focus necessary for the projection optical system, the size of the lens on the enlargement side tends to be increased. By using the relay optical system where the intermediate image MI is formed, irrespective of an optical system having a wide angle and a long back focus, a compact configuration can be achieved while suppressing an increase in the diameter of a lens. In FIG. 1, the intermediate image MI is conceptually indicated by a dotted line. The shape of the intermediate image MI in FIG. 1 does not need to be accurate.

For example, the projection optical system of FIG. 1 is a zoom lens, the first optical system G1 is fixed to the reduction-side imaging plane, and the second optical system G2 includes a lens group that moves during changing magnification. Hereinafter, the lens group that moves during changing magnification will be referred to as “movable lens group”. This way, with the configuration where the second optical system G2 includes the movable lens group instead of the first optical system G1 that is a wide-angle system. As a result, during changing magnification, a variation in field curvature and distortion can be suppressed.

For example, each of the optical systems in FIG. 1 is composed as follows. The first optical system G1 consists of lenses L1a to L1l in order from the enlargement side to the reduction side. The second optical system G2 consists of a second A lens group G2A, a second B lens group G2B, a second C lens group G2C, and a second D lens group G2D along the optical path in order from the enlargement side to the reduction side. The second A lens group G2A consists of lenses L2a to L2d in order from the enlargement side to the reduction side. The second B lens group G2B consists of a lens L2e. The second C lens group G2C consists of an aperture stop St and lenses L2f and L2i in order from the enlargement side to the reduction side. The second D lens group G2D consists of a lens L2j. The aperture stop St shown in FIG. 1 does not show the size or the shape thereof, but shows a position thereof in the optical axis direction. The method of showing the aperture stop St is the same in the other drawings.

In the present specification, in the second optical system G2, one lens group is a group of which a spacing to an adjacent group in the optical axis direction changes during changing magnification. That is, “lens group” is a component part of the second optical system G2, and is a part including at least one lens divided by an air spacing that changes during changing magnification. During changing magnification, a spacing between adjacent lenses does not change in one lens group. During changing magnification, the lens group units move or are fixed independently of each other. “Lens group” may include components having no power other than the lenses, for example, the aperture stop St and/or a planar mirror.

In the example of FIG. 1, during changing magnification, the second A lens group G2A and the second D lens group G2D are fixed to the reduction-side imaging plane, and the second B lens group G2B and the second C lens group G2C move while changing a mutual spacing. This way, the second optical system G2 that is a relay group is composed of four groups, which is advantageous in achieving a zoom lens having a wide angle of view. In general, among the lenses in the relay group, lenses on the enlargement side and the reduction side are likely to be lenses having a large diameter. Therefore, the second A lens group G2A on the enlargement side and the second D lens group G2D on the reduction side are fixed during changing magnification, and the second B lens group G2B and the second C lens group G2C are the movable lens groups such that the size of a mechanical mechanism for movement can be reduced. In addition, by fixing the second D lens group G2D during changing magnification, a variation in telecentricity during changing magnification can be suppressed. In FIG. 1, an arrow indicating a schematic moving direction of each of the movable lens group during changing magnification from a wide-angle end to a telephoto end is shown.

In the example of FIG. 1, each of the lenses L1a to L1c of the first optical system G1 is a single lens having a negative power, and the lens L1d is a single lens having a positive power. In the present specification, “single lens” refers to one uncemented lens. In addition, in the present specification, one single lens or one cemented lens is one lens component. Hereinafter, among the lens components in the projection optical system, a lens component having a positive power and closest to the enlargement side will be referred to as “P lens component LP”. In addition, a lens component having a negative power and disposed adjacent to the enlargement side of the P lens component LP will be referred to as “N lens component LN”. In the example of FIG. 1, the lens L1d corresponds to the P lens component LP, and the lens L1c corresponds to the N lens component LN.

In a case where the P lens component LP is a single lens, the refractive index of the P lens component LP with respect to the d line is preferably 1.65 or more. By setting the refractive index to 1.65 or more, the power required for the P lens component LP is easily ensured, which is advantageous in correcting various aberrations, in particular, correcting astigmatism. In order to obtain more satisfactory characteristics, the refractive index of the P lens component LP with respect to the d line is more preferably 1.7 or more and still more preferably 1.75 or more.

In a case where the N lens component NP is a single lens, the refractive index of the N lens component LN with respect to the d line is preferably 1.65 or less. By adjusting the refractive index to 1.65 or less, the power of the N lens component LN is not excessively strong, which is advantageous in correcting various aberrations, in particular, correcting spherical aberration and field curvature. In order to obtain more satisfactory characteristics, the refractive index of the N lens component LN with respect to the d line is more preferably 1.6 or less and still more preferably 1.57 or less.

It is preferable that the first optical system G1 includes an aspherical lens. The aspherical lens is disposed in the first optical system G1 that is a wide-angle system, which is advantageous in correcting field curvature and distortion. It is more preferable that the first optical system G1 includes two aspherical lenses. In this case, this configuration is more advantageous in correcting field curvature and distortion.

It is preferable that a lens surface closest to the enlargement side in the first optical system G1 is an aspherical surface that has a concave surface facing the enlargement side in a paraxial region and has an inflection point where an uneven shape changes halfway from the optical axis toward a peripheral portion. In this case, this configuration is advantageous in correcting distortion in the wide-angle system. In the present specification, “lens surface” refers to a surface through which a ray used for imaging transmits among the surfaces of a lens. In addition, the inflection point is a point where the surface shape switches from a convex shape to a concave shape or a point where the surface shape switches from a concave shape to a convex shape that is, a point where the sign of the curvature radius changes. The lens surface has the inflection point such that the refractive power of the peripheral portion of the lens can be determined without depending on the refractive power of the paraxial region.

In the projection optical system, it is preferable that the reduction side is telecentric. In a projection type display device that outputs a high-definition image, a three-plate system is adopted, and satisfactory telecentricity is required. In addition, in recent years, in order to achieve a small-sized high-definition projection type display device, a so-called pixel shift system in which a resolution of 2 times or 4 times the number of pixels of the display element is achieved by shifting the pixels has been increased. In order to ensure the resolution at this time, it is desirable to use a telecentric optical system.

It should be noted that “the reduction side is telecentric” includes an error that is practically allowed in the technical field to which the present disclosed technology belongs. The error may be, for example, in a range in which the angle between an optical axis Z and a principal ray incident on the reduction-side imaging plane in a case where ray tracing is performed from the enlargement side to the reduction side is −3 degrees or more and +3 degrees or less. In a system that does not include the aperture stop St, in a case where luminous fluxes are seen in a direction from the enlargement side to the reduction side, the telecentricity may be determined by using, as a substitute for the principal ray, an angle bisector between the maximum ray on the upper side and the maximum ray on the lower side in a cross section of a luminous flux focused on any point on the reduction-side imaging plane.

It is preferable that a focus group that performs focus adjustment of an entire image plane in a case where a projection distance changes by moving along the optical axis Z is disposed in the projection optical system. “The entire image plane” described herein refers to, for example, the entire projected image projected onto the screen Scr. Due to the movement of the focus group, adjustment of a position of a conjugate point on the optical axis during the change of the projection distance and correction of field curvature during the change of the projection distance can be performed. The above-described “adjustment of the position of the conjugate point” includes, for example, focusing. The projection optical system includes the focus group such that, during the change of the projection distance, focusing can be performed while maintaining optical performance up to the peripheral portion of the image plane.

For example, the projection optical system in the example of FIG. 1 includes only one focus group, and the focus group consists of lenses L1a to L1i. In FIG. 1, a parenthesis and a white two-way arrow parallel to the optical axis Z are shown below the lenses corresponding to the focus group. In the example of FIG. 1, during the focus adjustment, all of lens spacings in the focus group are invariable. In the drawings of the present application, a plurality of lenses shown in one parenthesis attached to an arrow indicating movement move integrally. “Move integrally” represents moving at the same time in the same direction by the same amount.

It is preferable that the focus group is disposed closest to the enlargement side in the projection optical system. In this case, the group configuration can be simplified.

It is preferable that the focus group is disposed in the first optical system G1. In this case, this configuration is advantageous in correcting collapse of an image plane during the change of the projection distance in an ultra wide-angle lens system.

In order to ensure performance during the change of the projection distance, it is preferable that the focus group includes six or more lenses. With the configuration where the focus group includes six or more lenses, even in a case where the projection optical system includes one focus group, the performance during the change of the projection distance is easily ensured. For example, the focus group of FIG. 1 consists of nine lenses.

It is preferable that the focus group includes two or more positive lenses. In this case, this configuration is advantageous in satisfactory correction of field curvature. For example, the focus group of FIG. 1 consists of five negative lenses and four positive lenses.

It is preferable that a lens surface closest to the enlargement side in the focus group is an aspherical surface that has a concave surface facing the enlargement side in a paraxial region and has an inflection point where an uneven shape changes halfway from the optical axis toward a peripheral portion. In this case, this configuration is advantageous in correcting distortion in the wide-angle lens system.

It is preferable that, among a first lens from the reduction side of the focus group and a second lens from the reduction side of the focus group, one lens is a negative lens and the other lens is a positive lens. In this case, this configuration is advantageous in suppressing a variation in lateral chromatic aberration during focus adjustment. In a case where, among the first lens from the reduction side of the focus group and the second lens from the reduction side of the focus group, one lens is a positive lens and the other lens is a negative lens, the negative lens and the positive lens may be cemented to each other. In a case where the cemented lens including the negative lens and the positive lens is disposed closest to the reduction side in the focus group, this configuration is more advantageous in suppressing a variation in lateral chromatic aberration during focus adjustment.

For example, in the example of FIG. 1, the lens L1i that is the first lens from the reduction side of the focus group is a negative lens, and the lens L1h that is the second lens from the reduction side of the focus group is a positive lens. In the example of FIG. 1, the lens L1i and the lens L1h are cemented to each other.

It is preferable that the lens surface closest to the reduction side in the focus group is a concave surface. In this case, this configuration is effective for correcting field curvature during focus adjustment.

It is preferable that a back focus correction group that performs back focus adjustment by moving along the optical axis Z is disposed in the projection optical system. In a case where error occurs such that a region from the vicinity of the optical axis to the peripheral portion of the image plane is uniformly out of focus, focusing can be performed due to the movement of the back focus correction group. As the factor for the error, error on the projection optical system side and/or error on the projection type display device in a case where the projection optical system is mounted on the projection type display device, out-of-focus caused by a temperature, or the influence of the gravity can be considered. The back focus correction group is not limited to the configuration consisting of a plurality of lenses, and may be a configuration consisting of only one lens.

For example, in the example of FIG. 1, the back focus correction group consists of the lens L1j. In FIG. 1, a parenthesis and a black two-way arrow parallel to the optical axis Z are shown below the lenses corresponding to the back focus correction group.

Both of the focus group and the back focus correction group may be disposed in the projection optical system. Both of the focus group and the back focus correction group are disposed in the projection optical system, which is advantageous in satisfactory focus adjustment.

In a case where both of the focus group and the back focus correction group are disposed in the projection optical system, it is preferable that the focus group and the back focus correction group are movable independently of each other. By performing the adjustment of the position of the conjugate point and the correction of field curvature independently of the back focus adjustment, the entire image plane can be adjusted to be in focus to obtain a satisfactory projected image.

In the projection optical system according to the present disclosure, it is preferable that all of the optical elements having a power are refraction type elements. In a projection optical system including reflection type optical element having a power, in general, a luminous flux near the optical axis reflected from a reflecting surface is shielded by the projection type display device and cannot be used for forming a projected image. Therefore, in order to avoid the light shielding, a central position of the image of the reduction-side imaging plane is configured to be shifted from the optical axis Z of the projection optical system, and the amount of shift is usually increased. Therefore, in the projection optical system including reflection type optical element having a power, the size of the reflecting surface having a power tends to be large, and thus it is difficult to achieve reduction in size thereof. In contrast, in the projection optical system where all of the optical elements having a power are refraction type elements, the luminous flux near the optical axis can be used for forming the projected image, and thus the amount of shift can be reduced even in a case where the shift is performed. By reducing the amount of shift, each optical element can be reduced in size. Therefore, the entire optical system can be led to reduction in size.

Next, preferable and possible configurations about conditional expressions of the projection optical system according to the present disclosure will be described. In the following description relating to the conditional expressions, in order to avoid redundant description, factors having the same definition will be represented by the same symbols, and the description thereof will not be repeated. Further, in the following description, in order to avoid redundant description, “the projection optical system according to the present disclosure” will also be simply referred to as “the projection optical system”. In a case where the projection optical system is a variable magnification optical system, all the symbols used in the following conditional expressions are values at the wide-angle end.

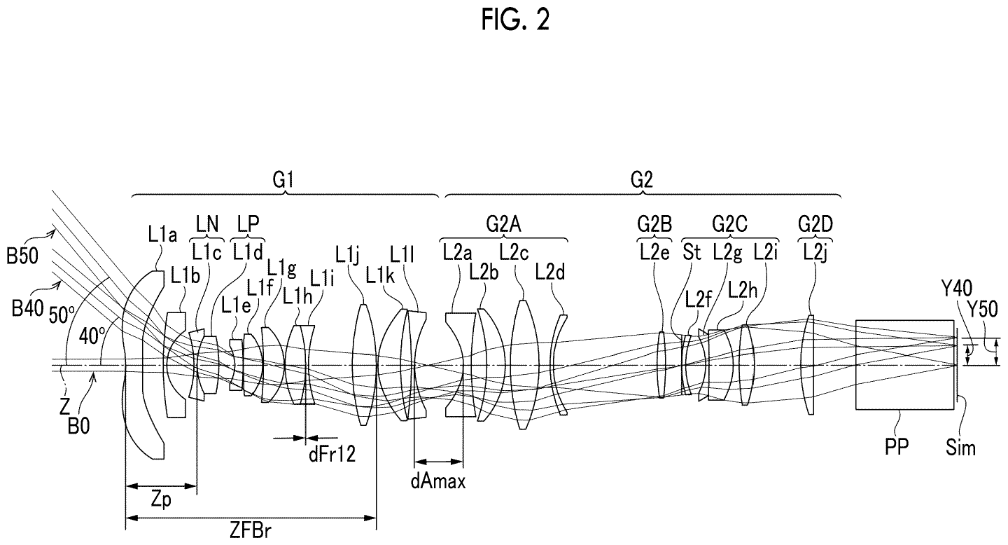

It is preferable that the projection optical system satisfies Conditional Expression (1). Here, a maximum image height on the reduction-side imaging plane is represented by Ymax. A distance on the optical axis from a surface of an optical element having a power closest to the enlargement side in the projection optical system to a lens surface closest to the enlargement side in the P lens component LP is represented by Zp. Examples of “the surface of the optical element having a power” include a lens surface, a mirror surface that is not flat, and a diffraction surface. For example, FIG. 1 shows the maximum image height Ymax, and FIG. 2 shows the distance Zp. FIG. 2 is a diagram for describing the symbols of each of the conditional expressions in the projection optical system of FIG. 1. By satisfying Conditional Expression (1), the P lens component LP can be disposed at a position that is effective for a reduction in size.

$$1 < Zp / Y max < 4 \qquad ( 1 )$$

In order to obtain more satisfactory characteristics, the lower limit value of Conditional Expression (1) is more preferably 1.5 and still more preferably 1.7. In order to obtain more satisfactory characteristics, the upper limit value of Conditional Expression (1) is more preferably 3 and still more preferably 2.5.

It is preferable that the projection optical system satisfies Conditional Expression (2). Here, a curvature radius of the lens surface closest to the enlargement side in the P lens component LP is represented by Rpf. By setting the corresponding value of Conditional Expression (2) not to be the lower limit value or less, the power of the lens surface closest to the enlargement side in the P lens component LP is not excessively strong, and thus the occurrence of aberrations can be suppressed. As a result, this configuration is advantageous in correcting various aberrations, in particular, correcting spherical aberration and field curvature. By setting the corresponding value of Conditional Expression (2) not to be the upper limit value or more, the power of the lens surface closest to the enlargement side in the P lens component LP is not excessively weak, which is advantageous in correcting high-order aberrations. As a result, this configuration facilitates a reduction in size while appropriately correcting various aberrations. In the present specification, “high-order” related to aberrations refers to the fifth order or higher.

$$0.2 < Rpf / Y max < 2.3 \qquad ( 2 )$$

In order to obtain more satisfactory characteristics, the lower limit value of Conditional Expression (2) is more preferably 0.5 and still more preferably 0.7. In order to obtain more satisfactory characteristics, the upper limit value of Conditional Expression (2) is more preferably 2 and still more preferably 1.8.

It is preferable that the projection optical system satisfies Conditional Expression (3). Here, a curvature radius of a lens surface closest to the reduction side in the N lens component LN is represented by Rnr. By setting the corresponding value of Conditional Expression (3) not to be the lower limit value or less, the power of the lens surface closest to the reduction side in the N lens component LN is not excessively strong, and thus the occurrence of aberrations can be suppressed. As a result, this configuration is advantageous in correcting various aberrations, in particular, correcting spherical aberration and field curvature. By setting the corresponding value of Conditional Expression (3) not to be the upper limit value or more, the power of the lens surface closest to the reduction side in the N lens component LN is not excessively weak, which is advantageous in correcting high-order aberrations. As a result, this configuration facilitates a reduction in size while appropriately correcting various aberrations.

$$0.2 < Rnr / Y max < 5 \qquad ( 3 )$$

In order to obtain more satisfactory characteristics, the lower limit value of Conditional Expression (3) is more preferably 0.5 and still more preferably 0.7. In order to obtain more satisfactory characteristics, the upper limit value of Conditional Expression (3) is more preferably 3 and still more preferably 2.5.

It is more preferable that the projection optical system simultaneously satisfies Conditional Expressions (1), (2), and (3). The P lens component LP is disposed at the position that satisfies Conditional Expression (1) and the two lens surfaces are configured to face each other with air as an interface such that the corresponding values are not the upper limit values or more of Conditional Expressions (2) and (3), which is advantageous in achieving a reduction in entire length of the optical system and a reduction in the diameter of the lens. Therefore, a reduction in the size of the optical system is facilitated.

It is preferable that the projection optical system satisfies Conditional Expression (4). Here, a back focus of the projection optical system on the reduction side in terms of an air conversion distance is represented by Bf. The corresponding value of Conditional Expression (4) is set not to be the lower limit value or less, which is advantageous in ensuring a long back focus. The corresponding value of Conditional Expression (4) is set not to be the upper limit value or more, which is advantageous in achieving a reduction in the entire length of the optical system and a reduction in lens diameter.

$$2 < Bf / Y max < 8 \qquad ( 4 )$$

In order to obtain more satisfactory characteristics, the lower limit value of Conditional Expression (4) is more preferably 2.5 and still more preferably 2.7. In order to obtain more satisfactory characteristics, the upper limit value of Conditional Expression (4) is more preferably 5 and still more preferably 4.

It is preferable that the projection optical system satisfies Conditional Expression (5). Here, an image height on the reduction-side imaging plane of a ray having a half angle of view of 40 degrees on the enlargement side is represented by Y40. An image height on the reduction-side imaging plane of a ray having a half angle of view of 50 degrees on the enlargement side is represented by Y50. For example, FIG. 2 shows a luminous flux B40 having a half angle of view of 40 degrees on the enlargement side, the image height Y40 on the reduction-side imaging plane of the luminous flux B40, a luminous flux B50 having a half angle of view of 50 degrees on the enlargement side, and the image height Y50 on the reduction-side imaging plane of the luminous flux B50. In FIG. 2 the angles between the principal rays in the luminous flux B40 and the luminous flux B50 and the optical axis Z are 40° and 50°, respectively. In the projection type display device, even an ultra wide angle projection optical system is required to project an image having no distortion. By satisfying Conditional Expression (5), it is easy to project an image having no distortion onto the screen Scr in the wide-angle optical system.

$$1.35 < Y 50 / Y 40 < 1.5 \qquad ( 5 )$$

In order to obtain more satisfactory characteristics, the lower limit value of Conditional Expression (5) is more preferably 1.37 and still more preferably 1.4. In order to obtain more satisfactory characteristics, the upper limit value of Conditional Expression (5) is more preferably 1.46 and still more preferably 1.44.

In the configuration where the half angle of view on the enlargement side is 55 degrees or more, it is preferable that the projection optical system satisfies Conditional Expression (5A). Here, an image height on the reduction-side imaging plane of a ray having a half angle of view of 55 degrees on the enlargement side is represented by Y55. By satisfying Conditional Expression (5A), it is easy to project an image having no distortion onto the screen Scr in the wider-angle optical system.

$$1.6 < Y 55 / Y 40 < 1.8 \qquad ( 5 A )$$

In order to obtain more satisfactory characteristics, the lower limit value of Conditional Expression (5A) is more preferably 1.65 and still more preferably 1.68. In order to obtain more satisfactory characteristics, the upper limit value of Conditional Expression (5A) is more preferably 1.75 and still more preferably 1.72.

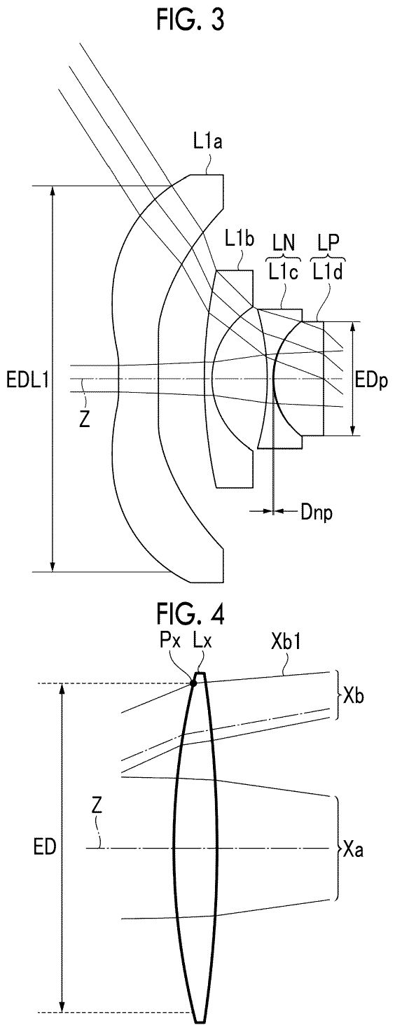

It is preferable that the projection optical system satisfies Conditional Expression (6). Here, a spacing on the optical axis between the N lens component LN and the P lens component LP is represented by Dnp. FIG. 3 is a partially enlarged view including the lenses L1a to L1d of the projection optical system of FIG. 1 and shows, for example, the spacing Dnp. Since the N lens component LN and the P lens component LP are different from each other, Dnp>0 is satisfied. In addition, since Ymax>0 is satisfied, the lower limit of Conditional Expression (6) satisfies Dnp/Ymax>0. The corresponding value of Conditional Expression (6) is set not to be the upper limit value or more, which is advantageous in correcting spherical aberration.

$$0 < Dnp / Y max < 0.1 \qquad ( 6 )$$

In order to improve manufacturability, the lower limit value of Conditional Expression (6) is more preferably 0.002 and still more preferably 0.004. In order to obtain more satisfactory characteristics, the upper limit value of Conditional Expression (6) is more preferably 0.05 and still more preferably 0.03.

It is preferable that the projection optical system satisfies Conditional Expression (7). Here, a curvature radius of the lens surface closest to the reduction side in the P lens component LP is represented by Rpr. The corresponding value of Conditional Expression (7) is set not to be the lower limit value or less, which is advantageous in correcting spherical aberration. The corresponding value of Conditional Expression (7) is set not to be the upper limit value or more, which is advantageous in correcting astigmatism.

$$0 < ( Rpr + Rpf ) / ( Rpr - Rpf ) < 2 \qquad ( 7 )$$

In order to obtain more satisfactory characteristics, the lower limit value of Conditional Expression (7) is more preferably 0.2 and still more preferably 0.3. In order to obtain more satisfactory characteristics, the upper limit value of Conditional Expression (7) is more preferably 1 and still more preferably 0.95.

It is preferable that the projection optical system satisfies Conditional Expression (8). Here, a larger value among a maximum effective diameter of the lens surface closest to the enlargement side in the P lens component LP and a maximum effective diameter of the lens surface closest to the reduction side in the P lens component LP is represented by EDp. For example, FIG. 3 shows the maximum effective diameter EDp. The corresponding value of Conditional Expression (8) is set not to be the lower limit value or less, which is advantageous in ensuring the required F number. By setting the corresponding value of Conditional Expression (8) not to be the upper limit value or more, the P lens component LP can be disposed near the pupil position, which is advantageous in reducing the size of the optical system.

$$0.5 < EDp / Y max < 2.5 \qquad ( 8 )$$

In order to obtain more satisfactory characteristics, the lower limit value of Conditional Expression (8) is more preferably 1 and still more preferably 1.2. In order to obtain more satisfactory characteristics, the upper limit value of Conditional Expression (8) is more preferably 2 and still more preferably 1.8.

Here, “the maximum effective diameter” in the present specification will be described with reference to FIG. 4. FIG. 4 is a diagram for description. In FIG. 4, the left side is an enlargement side, and the right side is a reduction side. FIG. 4 shows an on-axis luminous flux Xa and an off-axis luminous flux Xb passing through a lens Lx. In the example of FIG. 4, a ray Xb1 that is the maximum ray on the upper side of the off-axis luminous flux Xb is a ray passing through the outermost side. “The outer side” described herein is the radially outside with respect to the optical axis Z, that is, the side away from the optical axis Z. In the present specification, a position of an intersection between the ray passing through the outermost side and a lens surface is a position Px of the maximum effective diameter. In addition, a diameter that is two times the distance from the position Px of the maximum effective diameter to the optical axis Z is a maximum effective diameter ED of the enlargement-side surface of the lens Lx. In the example of FIG. 4, the maximum ray on the upper side of the off-axis luminous flux Xb is the ray passing through the outermost side, but the ray passing through the outermost side varies depending on the optical system.

It is preferable that the projection optical system satisfies Conditional Expression (9). Here, a curvature radius of the lens surface closest to the enlargement side in the N lens component LN is represented by Rnf. The corresponding value of Conditional Expression (9) is set not to be the lower limit value or less, which is advantageous in correcting field curvature. The corresponding value of Conditional Expression (9) is set not to be the upper limit value or more, which is advantageous in correcting astigmatism.

$$- 1 < ( Rnr + Rnf ) / ( Rnr - Rnf ) < 0.5 \qquad ( 9 )$$

In order to obtain more satisfactory characteristics, the lower limit value of Conditional Expression (9) is more preferably −0.8 and still more preferably −0.7. In order to obtain more satisfactory characteristics, the upper limit value of Conditional Expression (9) is more preferably 0.1 and still more preferably 0.05.

It is preferable that the projection optical system satisfies Conditional Expression (10). Here, a group consisting of all of lenses closer to the enlargement side than the movable lens group closest to the enlargement side among the movable lens groups in the projection optical system is an enlargement-side stationary group. A longest air spacing between lens surfaces on the optical axis in the enlargement-side stationary group is represented by dAmax. In the example of FIG. 1, the movable lens group closest to the enlargement side among the movable lens group in the projection optical system is the second B lens group G2B. In the example of FIG. 1, the enlargement-side stationary group consists of all of the lenses including the lens L1a to the lens L2d, and the spacing on the optical axis between the lens L1 and the lens L2a corresponds to the longest air spacing dAmax. For example, FIG. 2 shows the longest air spacing dAmax. By setting the corresponding value of Conditional Expression (10) not to be the lower limit value or less, an appropriate lens spacing can be ensured, which is advantageous in correcting lateral chromatic aberration and field curvature. The corresponding value of Conditional Expression (10) is set not to be the upper limit value or more, which is advantageous in reducing the entire length of the optical system.

$$0.2 < dA max / Y max < 2.5 \qquad ( 10 )$$

In order to obtain more satisfactory characteristics, the lower limit value of Conditional Expression (10) is more preferably 0.5 and still more preferably 1. In order to obtain more satisfactory characteristics, the upper limit value of Conditional Expression (10) is more preferably 2 and still more preferably 1.5.

In the configuration where the second optical system G2 consists of the second A lens group G2A, the second B lens group G2B, the second C lens group G2C, and the second D lens group G2D along the optical path in order from the enlargement side to the reduction side, during changing magnification, the second A lens group G2A and the second D lens group G2D are fixed to the reduction-side imaging plane, and the second B lens group G2B and the second C lens group G2C move while changing a mutual spacing, It is preferable that the projection optical system satisfies Conditional Expression (11). Here, a focal length of the second B lens group G2B is represented by f2B. A focal length of the second C lens group G2C is represented by f2C. In order to reduce the size of the projection optical system having a wide angle of view and a long back focus, a configuration where a positive power is disposed on the reduction side in the projection optical system is preferable. Accordingly, among the movable lens groups in the second optical system G2, a movable lens group having a strong power is a positive power, which is advantageous in reducing the size. By setting the corresponding value of Conditional Expression (11) not to be the lower limit value or less, among the movable lens groups in the second optical system G2, a movable lens group having a strong power can be made to be a positive power, which is advantageous in reducing the size. By setting the corresponding value of Conditional Expression (11) not to be the upper limit value or more, the absolute value of the power of the second C lens group G2C is not excessively larger than the power of the second B lens group G2B, which is advantageous in effectively correcting astigmatism.

$$0 < f 2 B / \vert f 2 C \vert < 0.5 \qquad ( 11 )$$

In order to obtain more satisfactory characteristics, the upper limit value of Conditional Expression (11) is more preferably 0.3 and still more preferably 0.2.

It is preferable that the projection optical system satisfies Conditional Expression (12). Here, a larger value among a maximum effective diameter of an enlargement-side surface of a lens closest to the enlargement side in the projection optical system and a maximum effective diameter of a reduction-side surface of the lens closest to the enlargement side in the projection optical system is represented by EDL1. For example, FIG. 3 shows the maximum effective diameter EDL1. A specific gravity of the lens closest to the enlargement side in the projection optical system is represented by pL1. The corresponding value of Conditional Expression (12) is set not to be the lower limit value or less, which is advantageous in correcting distortion. The corresponding value of Conditional Expression (12) is set not to be the upper limit value or more, which can contribute to a reduction in the weight of a wide-angle optical system where the lens closest to the enlargement side has the largest lens diameter.

$$0 .5 < EDL 1 \times ρ L 1 / Y max < 10 \qquad ( 12 )$$

In order to obtain more satisfactory characteristics, the lower limit value of Conditional Expression (12) is more preferably 1 and still more preferably 3. In order to obtain more satisfactory characteristics, the upper limit value of Conditional Expression (12) is more preferably 8 and still more preferably 6.

In the configuration where the back focus correction group that performs back focus adjustment by moving along the optical axis Z is disposed in the projection optical system, it is preferable that the projection optical system satisfies at least one of Conditional Expressions (18) or (19). Here, a paraxial lateral magnification of the back focus correction group is represented by BB. A combined paraxial lateral magnification of all of lenses closer to the reduction side than the back focus correction group is represented by βBr. An amount of change in an optical axis direction of a tangential image plane at a half angle of view of 50 degrees during movement of the back focus correction group by 0.1×Ymax in the optical axis direction is represented by ΔtB. BB, βBr, and ΔtB are values in a state where the magnification of the projection optical system is 120-fold.

$$\begin{matrix}0.1 < \vert ( 1 - β {B}^{2} ) \times β B {r}^{2} \vert < 2 & ( 18 ) \\ 0.7 < \vert ( 1 - β {B}^{2} ) \times β B {r}^{2} \vert / Δ tB < 1.4 & ( 19 )\end{matrix}$$

By setting the corresponding value of Conditional Expression (18) not to be the lower limit value or less, the amount of movement of the back focus correction group during the back focus adjustment can be suppressed, which is advantageous in reducing the size of the optical system. By setting the corresponding value of Conditional Expression (18) not to be the upper limit value or more, the amount of change of the back focus with respect to the amount of movement of the back focus correction group is not excessively large, which is advantageous in suppressing stricter fine adjustment of the back focus.

In order to obtain more satisfactory characteristics, the lower limit value of Conditional Expression (18) is more preferably 0.2 and still more preferably 0.25. In order to obtain more satisfactory characteristics, the upper limit value of Conditional Expression (18) is more preferably 1.5 and still more preferably 1.

Conditional Expression (19) is a conditional expression for adjusting the entire image plane to be in focus in a case where focusing for adjusting the amount of change in the back focus. By satisfying Conditional Expression (19), the entire image plane including both of the optical axis and the peripheral portion of the image plane is easily adjusted to be in focus.

In order to obtain more satisfactory characteristics, the lower limit value of Conditional Expression (19) is more preferably 0.75 and still more preferably 0.8. In order to obtain more satisfactory characteristics, the upper limit value of Conditional Expression (19) is more preferably 1.3 and still more preferably 1.2.

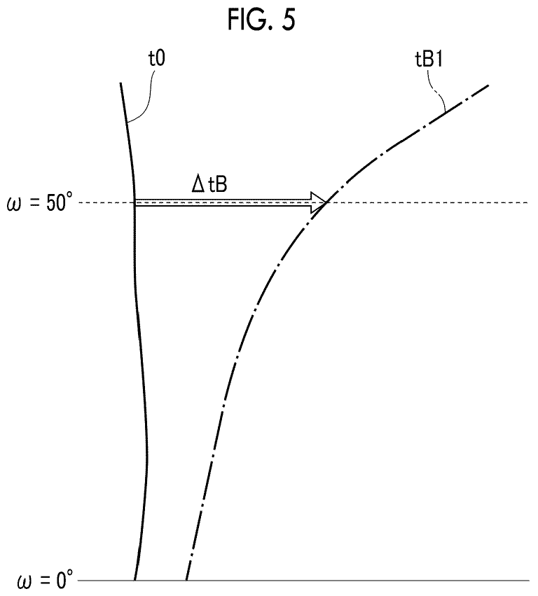

For example, FIG. 5 schematically shows the amount of change ΔtB using an arrow. In FIG. 5, the optical axis direction is the left-right direction of the drawing, a tangential image plane t0 based on a designed value is indicated by a solid line, and a tangential image plane tB1 during movement of the back focus correction group by 0.1×Ymax in the optical axis direction is indicated by a chain line. In FIG. 5, ω represents the half angle of view, a position corresponding to a half angle of view of 0 degrees is indicated by a thin solid line, and a position corresponding to a half angle of view of 50 degrees is indicated by a thin broken line.

In the configuration where the focus group that performs focus adjustment of an entire image plane in a case where a projection distance changes by moving along the optical axis Z is disposed in the projection optical system, it is preferable that the projection optical system satisfies at least one of Conditional Expressions (17) or (20). Here, a paraxial lateral magnification of the focus group is represented by βFF. A combined paraxial lateral magnification of all of lenses closer to the reduction side than the focus group is represented by βFFr. An amount of change in an optical axis direction of a tangential image plane at a half angle of view of 50 degrees during movement of the focus group by 0.1×Ymax in the optical axis direction is represented by ΔtFF. βFF, βFFr, and ΔtFF are values in a state where the magnification of the projection optical system is 120-fold.

$$\begin{matrix}0.02 < ( 1 - β {FF}^{2} ) \times β F F {r}^{2} < 0.2 & ( 17 ) \\ 0.1 < ( ( 1 - β {FF}^{2} ) \times β {FFr}^{2} ) / Δ t F F < 0.5 & ( 20 )\end{matrix}$$

The corresponding value of Conditional Expression (17) is set not to be the lower limit value or less, which is advantageous in focusing of the vicinity of the optical axis. The corresponding value of Conditional Expression (17) is set not to be the upper limit value or more, which is advantageous in adjusting the optical axis and the peripheral portion of the image plane to be in focus with a good balance.

In order to obtain more satisfactory characteristics, the lower limit value of Conditional Expression (17) is more preferably 0.03 and still more preferably 0.05. In order to obtain more satisfactory characteristics, the upper limit value of Conditional Expression (17) is more preferably 0.15 and still more preferably 0.13.

Conditional Expression (20) is a conditional expression for adjusting the optical axis and the peripheral portion of the image plane to be in focus with a good balance in a case where the projection distance changes in the wide-angle lens system. Conditional Expression (20) is satisfied, which is advantageous in adjusting both of the optical axis and the peripheral portion of the image plane to be in focus with a good balance.

In order to obtain more satisfactory characteristics, the lower limit value of Conditional Expression (20) is more preferably 0.2 and still more preferably 0.25. In order to obtain more satisfactory characteristics, the upper limit value of Conditional Expression (20) is more preferably 0.4 and still more preferably 0.35.

In the configuration where the focus group that performs focus adjustment of an entire image plane in a case where a projection distance changes by moving along the optical axis Z and the back focus correction group that performs back focus adjustment by moving along the optical axis Z are disposed in the projection optical system, it is preferable that the projection optical system satisfies both of Conditional Expressions (17) and (18).

In a case where the focus group includes six or more lenses, is disposed closest to the enlargement side in the projection optical system, and has a configuration where all of lens spacings in the focus group are invariable during the focus adjustment, it is preferable that the projection optical system satisfies at least one of Conditional Expressions (13) or (14). Here, a paraxial lateral magnification of the focus group is represented by βF. A combined paraxial lateral magnification of all of lenses closer to the reduction side than the focus group is represented by βFr. An amount of change in an optical axis direction of a tangential image plane at a half angle of view of 50 degrees during movement of the focus group by 0.1×Ymax in the optical axis direction is represented by ΔtF. βF, βFr, and ΔtF are values in a state where the magnification of the projection optical system is 120-fold.

$$\begin{matrix}0.02 < ( 1 - β {F}^{2} ) \times β {Fr}^{2} < 0.2 & ( 13 ) \\ 0.1 < ( ( 1 - β {F}^{2} ) \times β F {r}^{2} ) / Δ t F < 0.5 & ( 14 )\end{matrix}$$

The corresponding value of Conditional Expression (13) is set not to be the lower limit value or less, which is advantageous in focusing of the vicinity of the optical axis. The corresponding value of Conditional Expression (13) is set not to be the upper limit value or more, which is advantageous in adjusting the optical axis and the peripheral portion of the image plane to be in focus with a good balance.

In order to obtain more satisfactory characteristics, the lower limit value of Conditional Expression (13) is more preferably 0.03 and still more preferably 0.05. In order to obtain more satisfactory characteristics, the upper limit value of Conditional Expression (13) is more preferably 0.15 and still more preferably 0.13.

Conditional Expression (14) is a conditional expression for adjusting the optical axis and the peripheral portion of the image plane to be in focus with a good balance in a case where the projection distance changes in the wide-angle lens system. Conditional Expression (14) is satisfied, which is advantageous in adjusting both of the optical axis and the peripheral portion of the image plane to be in focus with a good balance.

In order to obtain more satisfactory characteristics, the lower limit value of Conditional Expression (14) is more preferably 0.2 and still more preferably 0.25. In order to obtain more satisfactory characteristics, the upper limit value of Conditional Expression (14) is more preferably 0.4 and still more preferably 0.35.

In the configuration, among the first lens from the reduction side of the focus group and the second lens from the reduction side of the focus group, one lens is a positive lens and the other lens is a negative lens, it is preferable that the projection optical system satisfies Conditional Expression (15). Here, a spacing on the optical axis between the first lens from the reduction side of the focus group and the second lens from the reduction side of the focus group is represented by dFr12. For example, FIG. 2 shows the spacing dFr12. Conditional Expression (15) is satisfied, which is advantageous in suppressing a variation in lateral chromatic aberration during focus adjustment.

$$0 \leq dFr 12 / Y max < 0. 1 \qquad ( 15 )$$

In the configuration where both of the focus group and the back focus correction group are disposed in the projection optical system, it is preferable that the projection optical system satisfies Conditional Expression (16). A distance on the optical axis from a lens surface closest to the enlargement side in the first optical system G1 to a lens surface closest to the reduction side among lens surfaces in the focus group and the back focus correction group is represented by ZFBr. For example, FIG. 2 shows the distance ZFBr. By setting the corresponding value of Conditional Expression (16) not to be the lower limit value or less, it is easily ensure a space for disposing both of the focus group and the back focus correction group. By setting the corresponding value of Conditional Expression (16) not to be the upper limit value or more, the position of the focus group or the back focus correction group is not excessively close to the reduction side, which is advantageous in ensuring satisfactory operability.

$$5 < ZFBr / \vert f \vert < 20 \qquad ( 16 )$$

In order to obtain more satisfactory characteristics, the lower limit value of Conditional Expression (16) is more preferably 7 and still more preferably 10. In order to obtain more satisfactory characteristics, the upper limit value of Conditional Expression (16) is more preferably 19 and still more preferably 15.

The preferable configurations and available configurations including the configurations regarding the conditional expressions can be freely combined within a range where they do not contradict each other, and it is preferable to appropriately selectively adopt the combination according to required specifications. Various modifications can be made without departing from the scope of the present disclosed technology. For example, in the present disclosed technology, the number of lenses included in each of the groups and each of the optical systems and the shapes of the lenses may be different from those in the example of FIG. 1. During changing magnification, the stationary group, the movable lens group, and the focus group, and the back focus correction group may be different from those of FIG. 1.

In the example of FIG. 1, the back focus correction group is disposed closer to the reduction side than the focus group. More specifically, the back focus correction group is disposed adjacent to the focus group. However, in the present disclosed technology, the focus group and the back focus correction group can also be configured not to be adjacent to each other. In this case, the back focus correction group may be disposed adjacent to the reduction side of the intermediate image MI.

The back focus correction group may be configured to consist of one lens. More specifically, the back focus correction group may be configured to consist of one positive lens. Alternatively, the back focus correction group may be configured to consist of three positive lenses. For example, the back focus correction group may be configured to consist of one negative lens and two positive lenses.

Based on the above configurations, according to one preferable aspect of the present disclosure, there is provided a projection optical system that projects an image on a reduction-side imaging plane onto an enlargement-side imaging plane, a half angle of view on an enlargement side is 50 degrees or more, in a case where one lens component is one single lens or one cemented lens, the projection optical system includes a P lens component LP that is a lens component having a positive power and closest to the enlargement side among lens components in the projection optical system and an N lens component LN that is a lens component having a negative power and disposed adjacent to the enlargement side of the P lens component LP, and Conditional Expressions (1), (2), (3), (4), and (5) are satisfied.

According to another preferable aspect of the present disclosure, there is provided a projection optical system consisting of a first optical system G1 and a second optical system G2 along an optical path in order from an enlargement side to a reduction side, in which the second optical system G2 forms an intermediate image MI at a position conjugate to a reduction-side imaging plane between the first optical system G1 and the second optical system G2, and the first optical system G1 re-forms the intermediate image MI on an enlargement-side imaging plane, a focus group that includes six or more lenses and performs focus adjustment of an entire image plane in a case where a projection distance changes by moving along the optical axis Z is disposed closest to the enlargement side in the projection optical system, and all of lens spacings in the focus group are invariable during the focus adjustment.

According to still another preferable aspect of the present disclosure, there is provided a projection optical system consisting of a first optical system G1 and a second optical system G2 along an optical path in order from an enlargement side to a reduction side, in which the second optical system G2 forms an intermediate image MI at a position conjugate to a reduction-side imaging plane between the first optical system G1 and the second optical system G2, and the first optical system G1 re-forms the intermediate image MI on an enlargement-side imaging plane, a focus group that performs focus adjustment of an entire image plane in a case where a projection distance changes by moving along the optical axis Z and a back focus correction group that performs back focus adjustment by moving along the optical axis Z are disposed in the projection optical system, and Conditional Expression (16) is satisfied.

Next, examples of the projection optical system according to the present disclosure will be described, with reference to the drawings. It should be noted that the reference numerals attached to the lenses, the lens groups, and the optical systems in the cross-sectional views of each example are used independently for each example in order to avoid complication of description and drawings caused by an increase in number of digits of the reference numerals. Therefore, even in a case where common reference numerals are attached in the drawings of different examples, components do not necessarily have a common configuration.

### Example 1

FIG. 1 shows a cross-sectional view of a configuration and luminous fluxes of a projection optical system according to Example 1, and an Illustration method and a configuration thereof are the same as described above. Thus, some of repeated description will not be given. The projection optical system according to Example 1 consists of a first optical system G1 and a second optical system G2 along the optical path in order from the enlargement side to the reduction side. The second optical system G2 consists of a second A lens group G2A having a positive power, a second B lens group G2B having a positive power, a second C lens group G2C having a positive power, and a second D lens group G2D having a positive power along the optical path in order from the enlargement side to the reduction side.

Regarding the projection optical system according to Example 1, Tables 1A and 1B show basic lens data, Table 2 shows specifications and variable surface spacings during changing magnification, Table 3 shows variable surface spacings during focusing, and Table 4 shows aspherical coefficients. Here, the basic lens data is shown to be divided into two tables including Tables 1A and 1B, in order to avoid an increase in length of one table. Table 1A shows the first optical system G1 and Table 1B shows the second optical system G2.

The table of the basic lens data is described as follows. The “Sn” column shows surface numbers in a case where the surface closest to the enlargement side is the first surface and the number is increased one by one toward the reduction side. The R column shows a curvature radius of each surface. The D column shows a surface spacing between each surface and the surface adjacent to the reduction side on the optical axis. The Nd column shows a refractive index of each component at the d line. The vd column shows an Abbe number of each component with respect to the d line. The ED column refers to the maximum effective diameter of each surface regarding the lens closest to the enlargement side and the P lens component LP.

In the table of the basic lens data, the sign of the curvature radius of a surface that is convex to the enlargement side is positive, and the sign of the curvature radius of a surface that is convex to the reduction side is negative. In the fields of the surface number of the surface corresponding to the aperture stop St, the surface number and the expression (St) are shown. The table of basic lens data also shows the optical member PP. The value in the bottom field of the column D in the table indicates a spacing between the display surface Sim and the surface closest to the reduction side in the table. The symbol DD[ ] is used for the variable surface spacing during changing magnification, and the surface number of the enlargement-side surface of the spacing is given in [ ] and is shown in the column D.

Table 2 shows a zoom ratio Zr, an absolute value |f| of the focal length, a back focus Bf in terms of the air conversion distance, a F number F No., a maximum total angle of view 2ω, and a variable surface spacing during changing magnification with respect to the d line. [°] in the fields of 2ω indicates that the unit thereof is a degree. In Table 2, the values in the wide-angle end state, the middle focal length state, and the telephoto end state are respectively shown in the columns labeled with “WIDE”, “MIDDLE”, and “TELE”.

In Example 1, in a case where the projection distance is changed, focusing is performed by changing the spacing between the seventeenth surface and the eighteenth surface. Table 3 shows the variable surface spacing during focusing at each of the projection distances. The projection distance is a distance on the optical axis from the enlargement-side imaging plane (in FIG. 1, corresponding to the screen Scr) to the lens surface closest to the enlargement side.

In the basic lens data, a reference sign * is attached to surface numbers of aspherical surfaces, and values of paraxial curvature radius are shown in the fields of the curvature radius of the aspherical surface. In Table 4, the Sn row shows surface numbers of the aspherical surfaces, and the KA and Am rows show numerical values of the aspherical coefficients for each aspherical surface. Here, m of Am represents an integer of 3 or more and varies depending on the surface. For example, in the first surface of Example 1, m=3, 4, 5, . . . , and 20. The “E±n” (n: an integer) in the numerical values of the aspherical coefficients of Table 4 indicates “×10^{±n} ”. KA and Am are the aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ A m \times {h}^{m}$$

Here,
Zd is an aspherical surface depth (a length of a perpendicular from a point on an aspherical surface at a height h to a plane that is perpendicular to the optical axis Z and in contact with the aspherical surface apex),
h is a height (a distance from the optical axis Z to the lens surface),
C is a reciprocal of the paraxial curvature radius,
KA and Am are aspherical coefficients, and
Σ in the aspheric equation represents the total sum regarding m.

In the data of each of the tables, degrees are used as the unit of an angle, and millimeters (mm) are used as the unit of a length. However, appropriate different units may be used because the optical system can be used even in a case where the system is enlarged or reduced in proportion. Further, each of the following tables shows numerical values rounded off to predetermined decimal places.

TABLE 1A
Example 1

| Sn | R | D | Nd | νd | ED |
|---|---|---|---|---|---|
| *1 | −18.7529 | 4.6414 | 1.53638 | 56.09 | 50.7 |
| *2 | −47.9264 | 5.5314 | | | 41.3 |
| 3 | 86.0793 | 0.9283 | 1.60311 | 60.64 | |
| 4 | 10.9830 | 7.3525 | | | |
| 5 | −27.3343 | 0.7589 | 1.51742 | 52.43 | |
| 6 | 15.7504 | 0.0847 | | | |
| 7 | 16.2239 | 5.8971 | 1.83481 | 42.72 | 16.7 |
| 8 | −37.0006 | 4.3415 | | | 15.2 |
| 9 | −10.3255 | 2.2345 | 1.80518 | 25.46 | |
| 10 | −89.9292 | 0.1693 | | | |
| *11 | 153.2666 | 4.9460 | 1.58313 | 59.38 | |
| *12 | −11.1635 | 0.1680 | | | |
| 13 | −98.1504 | 5.6831 | 1.49700 | 81.61 | |
| 14 | −13.9252 | 0.1694 | | | |
| 15 | 23.8746 | 5.6060 | 1.43700 | 95.10 | |
| 16 | −38.5119 | 0.7587 | 1.84666 | 23.78 | |
| 17 | 33.8526 | 11.8860 | | | |
| 18 | 59.1568 | 6.4743 | 1.80420 | 46.50 | |
| 19 | −49.2869 | 0.4228 | | | |
| 20 | 20.9556 | 6.1554 | 1.80420 | 46.50 | |
| 21 | 60.4191 | 2.9031 | | | |
| 22 | −110.8739 | 0.8433 | 1.51680 | 64.20 | |
| 23 | 25.2741 | 13.2159 | | | |

TABLE 1B
Example 1

| Sn | R | D | Nd | νd |
|---|---|---|---|---|
| 24 | −16.2790 | 2.1579 | 1.51680 | 64.20 |
| 25 | 78.2294 | 4.1671 | | |
| 26 | −41.6115 | 5.0326 | 1.84666 | 23.78 |
| 27 | −22.4603 | 1.3793 | | |
| 28 | 60.5566 | 7.7750 | 1.77250 | 49.62 |
| 29 | −43.2696 | 2.9629 | | |
| 30 | 33.4323 | 0.8861 | 1.80518 | 25.46 |
| 31 | 23.5155 | DD[31] | | |
| 32 | 55.5358 | 2.1906 | 1.83481 | 42.72 |
| 33 | −100.5849 | DD[33] | | |
| 34(St) | 30.9398 | 1.0162 | 1.56732 | 42.82 |
| 35 | 19.4457 | 5.4838 | | |
| 36 | −16.6916 | 0.7165 | 1.84666 | 23.78 |
| 37 | −674.1161 | 0.1879 | | |
| 38 | −163.7848 | 6.5325 | 1.49700 | 81.61 |
| 39 | −18.7884 | 1.5699 | | |
| 40 | 64.0741 | 4.0249 | 1.49700 | 81.61 |
| 41 | −34.6927 | DD[41] | | |
| 42 | 40.4952 | 3.5412 | 1.84666 | 23.78 |
| 43 | −2363.1072 | 11.4473 | | |
| 44 | ∞ | 26.5148 | 1.51680 | 64.20 |
| 45 | ∞ | 0.8689 | | |

TABLE 2
Example 1

| | WIDE | MIDDLE | TELE |
|---|---|---|---|
| Zr | 1.00 | 1.03 | 1.10 |
| \|f\| | 6.17 | 6.36 | 6.78 |
| Bf | 29.7 | 29.7 | 29.7 |
| FNo. | 1.81 | 1.83 | 1.85 |
| 2ω[°] | 116.4 | 114.8 | 111.6 |
| DD[31] | 28.05 | 26.38 | 23.25 |
| DD[33] | 4.48 | 4.86 | 6.36 |
| DD[41] | 12.49 | 13.79 | 15.41 |

TABLE 3
Example 1

| | | | |
|---|---|---|---|
| Projection Distance | 725.7 | 543.9 | 3628 |
| Spacing between | 11.8860 | 12.0698 | 11.4416 |
| Seventeenth Surface | | | |
| and Eighteenth Surface | | | |

TABLE 4
Example 1

| Sn | 1 | 2 |
|---|---|---|
| KA | −3.3984076E−01 | 3.2606567E+00 |
| A3 | −1.1533329E−03 | −9.5623401E−04 |
| A4 | 8.4795366E−04 | 7.4016254E−04 |
| A5 | −8.7274695E−05 | −6.2685288E−05 |
| A6 | 1.5004900E−06 | −3.0169668E−06 |
| A7 | 4.1884776E−07 | 9.2830841E−07 |
| A8 | −3.1043653E−08 | −4.5929568E−08 |
| A9 | −3.0934931E−10 | −3.0996297E−09 |
| A10 | 1.1882682E−10 | 3.6536814E−10 |
| A11 | −2.9410201E−12 | −1.3422567E−13 |
| A12 | −1.9441646E−13 | −1.2088474E−12 |
| A13 | 9.8268202E−15 | 2.9777959E−14 |
| A14 | 1.0948402E−16 | 1.9025081E−15 |
| A15 | −1.3552578E−17 | −7.9815510E−17 |
| A16 | 7.5079767E−20 | −1.2451577E−18 |
| A17 | 9.0235272E−21 | 8.9910364E−20 |
| A18 | −1.2502550E−22 | −1.5838152E−22 |
| A19 | −2.3881645E−24 | −3.7737995E−23 |
| A20 | 4.5122192E−26 | 3.9154743E−25 |

| Sn | 11 | 12 |
|---|---|---|
| KA | 1.0000000E+00 | 1.0000000E+00 |
| A3 | 0.0000000E+00 | 0.0000000E+00 |
| A4 | −1.1548980E−04 | 4.4205676E−05 |
| A5 | 8.1318777E−06 | 1.5305271E−05 |
| A6 | 2.3862847E−06 | −4.3285372E−06 |
| A7 | −4.3543592E−07 | 7.1192275E−07 |
| A8 | 9.8647737E−09 | −1.1617508E−08 |
| A9 | 3.3697300E−09 | −6.1444535E−09 |
| A10 | −1.8883031E−10 | 5.1744340E−10 |

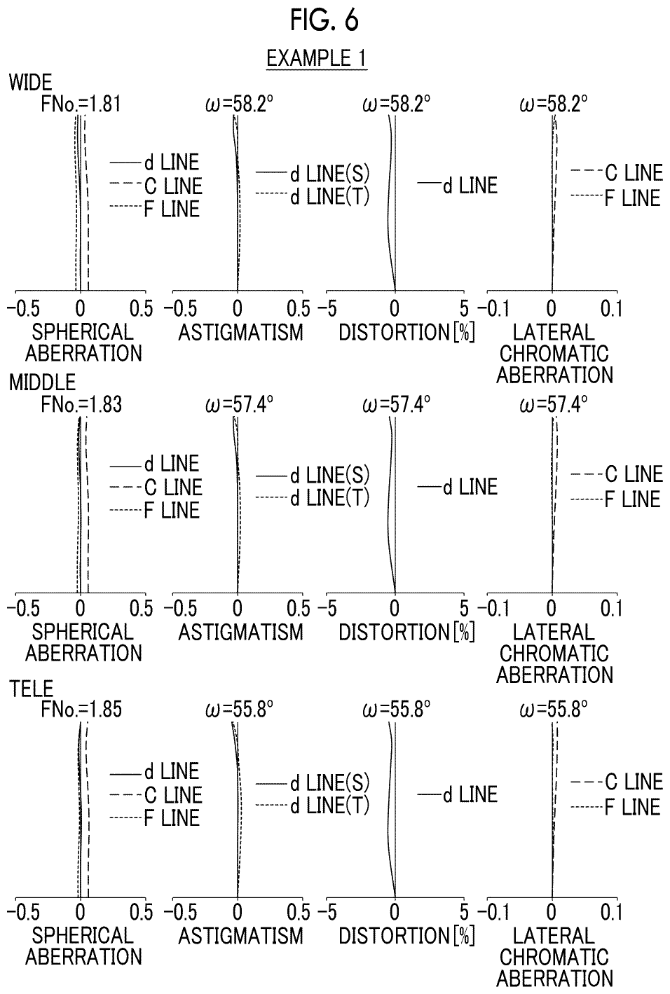

FIG. 6 shows each of aberration diagrams in the projection optical system according to Example 1 in a state where the projection distance is 725.7 millimeters (mm). In FIG. 6, the upper part labeled “WIDE” shows aberrations in the wide-angle end state, the middle part labeled “MIDDLE” shows aberrations in the middle focal length state, and the lower part labeled “TELE” shows aberrations in the telephoto end state. FIG. 6 shows spherical aberration, astigmatism, distortion, and lateral chromatic aberration in order from the left side. In the spherical aberration diagram, aberrations regarding the d line, the C line, and the F line are indicated by a solid line, a long broken line, and a short broken line, respectively. In the astigmatism diagram, an aberration regarding the d line in the sagittal direction is indicated by a solid line, and an aberration regarding the d line in the tangential direction is indicated by a short broken line. In the distortion diagram, an aberration regarding the d line is indicated by a solid line. In the lateral chromatic aberration diagram, aberrations regarding the C line and the F line are indicated by a long broken line and a short broken line, respectively. In the spherical aberration diagram, a value of the F number is shown after “F No.=”. In other aberration diagrams, the value of the maximum half angle of view is shown after “ω=”. In the aberration diagrams other than the distortion diagram, the unit of the horizontal axis is millimeter (mm).

Symbols, meanings, description methods, and illustration methods of the respective data pieces according to Example 1 are basically similar to those in the following examples unless otherwise specified. Therefore, hereinafter, repeated description will not be given. It should be noted that in the cross-sectional view of the following examples, the screen Scr is not shown.

### Example 2

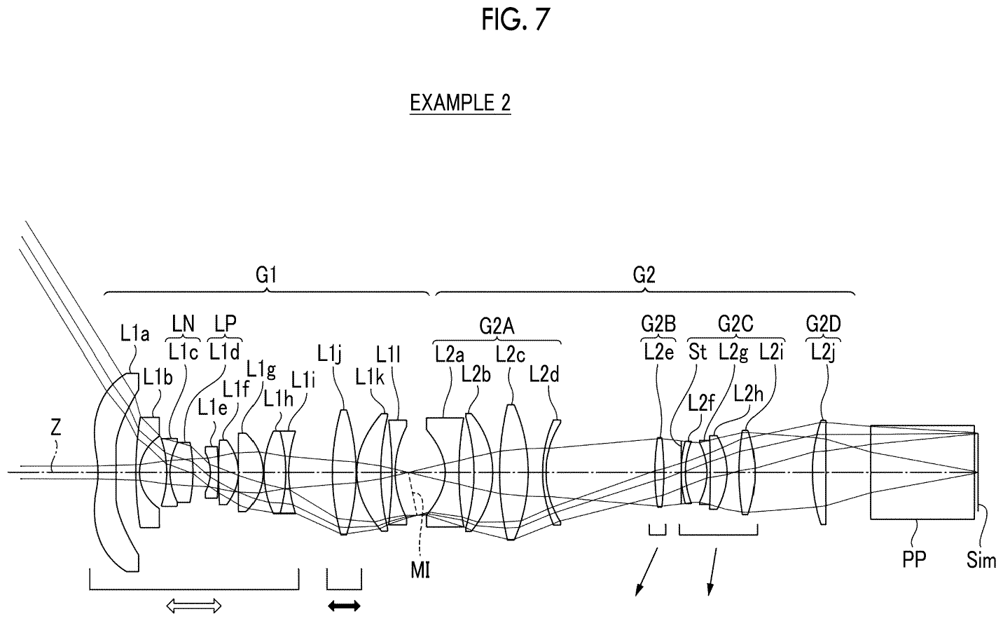

FIG. 7 shows a cross-sectional view of a configuration and luminous fluxes of a projection optical system according to Example 2. The projection optical system according to Example 2 consists of a first optical system G1 and a second optical system G2 in order from the enlargement side to the reduction side. The second optical system G2 consists of a second A lens group G2A having a positive power, a second B lens group G2B having a positive power, a second C lens group G2C having a positive power, and a second D lens group G2D having a positive power in order from the enlargement side to the reduction side. During changing magnification, the second A lens group G2A and the second D lens group G2D are fixed to the display surface Sim, and the second B lens group G2B and the second C lens group G2C move while changing a mutual spacing.

The first optical system G1 consists of lenses L1a to L1l in order from the enlargement side to the reduction side. The second A lens group G2A consists of lenses L2a to L2d in order from the enlargement side to the reduction side. The second B lens group G2B consists of a lens L2e. The second C lens group G2C consists of an aperture stop St and lenses L2f and L2i in order from the enlargement side to the reduction side. The second D lens group G2D consists of a lens L2j. The lens L1d corresponds to the P lens component LP, and the lens L1c corresponds to the N lens component LN. The focus group consists of lenses L1a to L1i. The back focus correction group consists of the lens L1j.

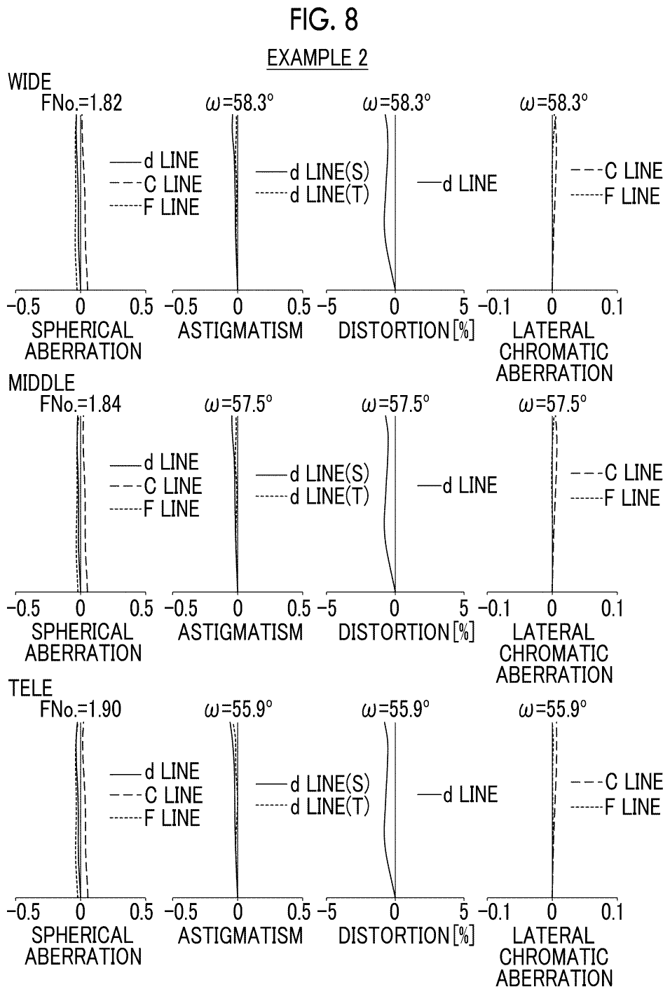

Regarding the projection optical system according to Example 2, Tables 5A and 5B show basic lens data, Table 6 shows specifications and variable surface spacings during changing magnification, Table 7 shows variable surface spacings during focusing, Table 8 shows aspherical coefficients, and FIG. 8 shows each of the aberration diagrams. Each of aberration diagrams is in a state where the projection distance is 725.7 millimeters (mm).

TABLE 5A
Example 2

| Sn | R | D | Nd | νd | ED |
|---|---|---|---|---|---|
| *1 | −18.7529 | 4.6420 | 1.53638 | 56.09 | 48.40 |
| *2 | −53.6187 | 5.2411 | | | 38.1 |
| 3 | 84.0537 | 0.8431 | 1.58913 | 61.25 | |
| 4 | 10.6571 | 6.9837 | | | |
| 5 | −28.1221 | 0.7588 | 1.51742 | 52.43 | |
| 6 | 13.4634 | 0.0847 | | | |
| 7 | 13.7793 | 5.6062 | 1.83481 | 42.72 | 15.60 |
| 8 | −45.5846 | 4.8379 | | | 14 |
| 9 | −9.8378 | 1.8318 | 1.80518 | 25.46 | |
| 10 | −80.3381 | 0.1680 | | | |
| *11 | 124.7030 | 5.1469 | 1.58313 | 59.38 | |
| *12 | −10.7709 | 0.1681 | | | |
| 13 | −155.2206 | 5.8778 | 1.49700 | 81.61 | |
| 14 | −14.1795 | 0.1694 | | | |
| 15 | 23.8896 | 6.1221 | 1.43700 | 95.10 | |
| 16 | −28.8733 | 0.7588 | 1.84666 | 23.78 | |
| 17 | 37.3324 | 10.6122 | | | |
| 18 | 54.7048 | 6.2003 | 1.87070 | 40.73 | |
| 19 | −53.6262 | 0.4212 | | | |
| 20 | 21.1550 | 5.7863 | 1.80420 | 46.50 | |
| 21 | 64.3645 | 2.8176 | | | |
| 22 | −97.9560 | 0.8431 | 1.51680 | 64.20 | |
| 23 | 25.4285 | 12.5906 | | | |

TABLE 5B
Example 2

| Sn | R | D | Nd | νd |
|---|---|---|---|---|
| 24 | −15.6618 | 3.6952 | 1.51680 | 64.20 |
| 25 | 80.3302 | 4.2247 | | |
| 26 | −39.5458 | 4.3209 | 1.92286 | 20.88 |
| 27 | −22.9169 | 1.7461 | | |
| 28 | 69.1650 | 7.7775 | 1.77250 | 49.62 |
| 29 | −39.9179 | 3.4055 | | |
| 30 | 34.7983 | 0.8432 | 1.80518 | 25.46 |
| 31 | 24.5641 | DD[31] | | |
| 32 | 59.5554 | 2.1264 | 1.83481 | 42.72 |
| 33 | −105.6767 | DD[33] | | |
| 34(St) | 31.6945 | 0.7587 | 1.58144 | 40.75 |
| 35 | 20.4322 | 5.4850 | | |
| 36 | −17.9939 | 0.7165 | 1.84666 | 23.78 |
| 37 | 150.6574 | 0.1012 | | |
| 38 | 222.0404 | 4.5030 | 1.49700 | 81.61 |
| 39 | −19.6808 | 3.0116 | | |
| 40 | 69.9247 | 4.2293 | 1.49700 | 81.61 |
| 41 | −30.1856 | DD[41] | | |
| 42 | 42.5432 | 3.3924 | 1.92286 | 20.88 |
| 43 | ∞ | 11.4473 | | |
| 44 | ∞ | 26.5148 | 1.51680 | 64.20 |
| 45 | ∞ | 0.8645 | | |

TABLE 6
Example 2

| | WIDE | MIDDLE | TELE |
|---|---|---|---|
| Zr | 1.00 | 1.03 | 1.10 |
| \|f\| | 6.16 | 6.36 | 6.78 |
| Bf | 29.7 | 29.7 | 29.7 |
| FNo. | 1.82 | 1.84 | 1.90 |
| 2ω[°] | 116.6 | 115.0 | 111.8 |
| DD[31] | 27.82 | 26.11 | 22.90 |
| DD[33] | 4.72 | 5.26 | 7.15 |
| DD[41] | 14.41 | 15.58 | 16.91 |

TABLE 7
Example 2

| | | | |
|---|---|---|---|
| Projection Distance | 725.7 | 543.9 | 3628 |
| Spacing between | 10.6122 | 10.7906 | 10.1815 |
| Seventeenth Surface | | | |
| and Eighteenth Surface | | | |

TABLE 8
Example 2

| Sn | 1 | 2 |
|---|---|---|
| KA | −3.8830039E−01 | 3.1728047E+00 |
| A3 | −1.2805380E−03 | −1.0037911E−03 |
| A4 | 9.1761293E−04 | 7.9324991E−04 |
| A5 | −9.6009302E−05 | −6.9949142E−05 |
| A6 | 1.6832339E−06 | −2.9763575E−06 |
| A7 | 4.7708119E−07 | 1.0615030E−06 |
| A8 | −3.6139672E−08 | −6.2753494E−08 |
| A9 | −3.5913752E−10 | −3.0983201E−09 |
| A10 | 1.4410229E−10 | 4.9805128E−10 |
| A11 | −3.6874415E−12 | −5.7748607E−12 |
| A12 | −2.4510294E−13 | −1.6572325E−12 |
| A13 | 1.2809792E−14 | 6.2856142E−14 |
| A14 | 1.4127819E−16 | 2.4457524E−15 |
| A15 | −1.8419313E−17 | −1.6156227E−16 |
| A16 | 1.0869476E−19 | −9.2148134E−19 |
| A17 | 1.2794035E−20 | 1.8726091E−19 |
| A18 | −1.8381311E−22 | −1.5465660E−21 |
| A19 | −3.5332510E−24 | −8.2602574E−23 |
| A20 | 6.8930882E−26 | 1.2959499E−24 |

| Sn | 11 | 12 |
|---|---|---|
| KA | 1.0000000E+00 | 1.0000000E+00 |
| A3 | 0.0000000E+00 | 0.0000000E+00 |
| A4 | −1.1236836E−04 | 9.5732039E−06 |
| A5 | −4.1195200E−07 | 3.5470350E−05 |
| A6 | 4.7690386E−06 | −9.4457094E−06 |
| A7 | −6.5125990E−07 | 1.2102930E−06 |
| A8 | −4.1142098E−09 | 1.0767388E−08 |
| A9 | 6.9360694E−09 | −1.3908562E−08 |
| A10 | −3.5540008E−10 | 9.4575778E−10 |

### Example 3

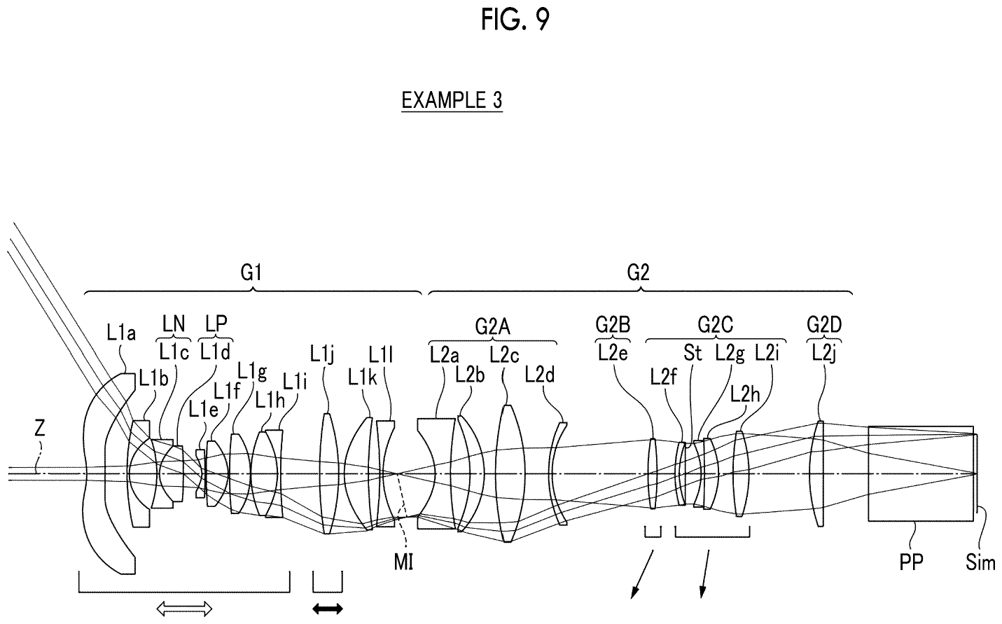

FIG. 9 shows a cross-sectional view of a configuration and luminous fluxes of a projection optical system according to Example 3. The projection optical system according to Example 3 consists of a first optical system G1 and a second optical system G2 in order from the enlargement side to the reduction side. The second optical system G2 consists of a second A lens group G2A having a positive power, a second B lens group G2B having a positive power, a second C lens group G2C having a positive power, and a second D lens group G2D having a positive power in order from the enlargement side to the reduction side. During changing magnification, the second A lens group G2A and the second D lens group G2D are fixed to the display surface Sim, and the second B lens group G2B and the second C lens group G2C move while changing a mutual spacing.

The first optical system G1 consists of lenses L1a to L1l in order from the enlargement side to the reduction side. The second A lens group G2A consists of lenses L2a to L2d in order from the enlargement side to the reduction side. The second B lens group G2B consists of a lens L2e. The second C lens group G2C consists of an aperture stop St, a lens L2f, and lenses L2g and L2i in order from the enlargement side to the reduction side. The second D lens group G2D consists of a lens L2j. The lens L1d corresponds to the P lens component LP, and the lens L1c corresponds to the N lens component LN. The focus group consists of lenses L1a to L1i. The back focus correction group consists of the lens L1j.

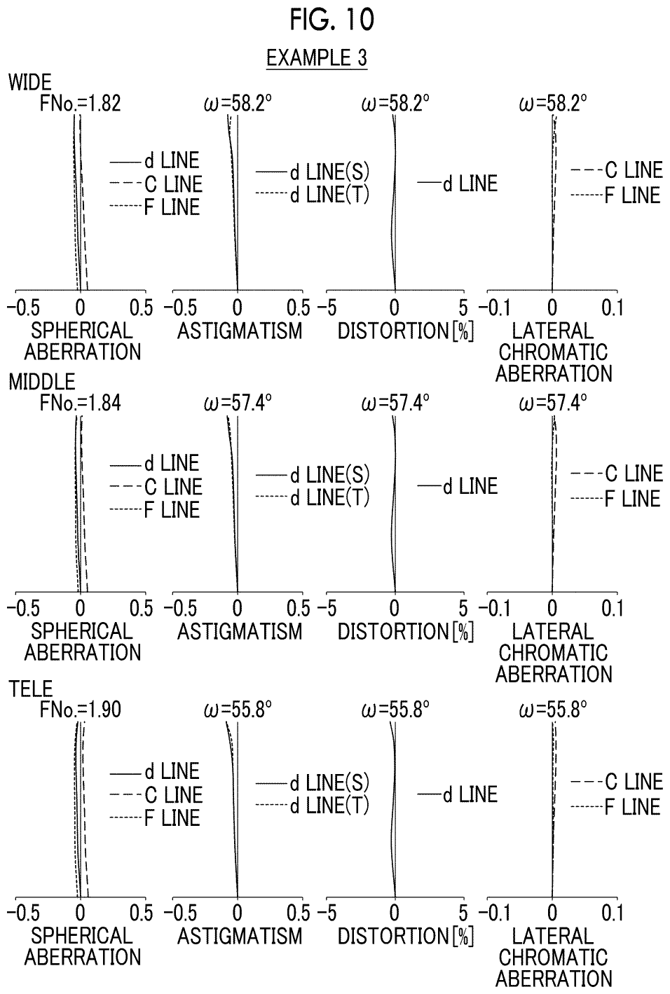

Regarding the projection optical system according to Example 3, Tables 9A and 9B show basic lens data, Table 10 shows specifications and variable surface spacings during changing magnification, Table 11 shows variable surface spacings during focusing, Table 12 shows aspherical coefficients, and FIG. 10 shows each of the aberration diagrams. Each of aberration diagrams is in a state where the projection distance is 725.7 millimeters (mm).

TABLE 9A
Example 3

| Sn | R | D | Nd | νd | ED |
|---|---|---|---|---|---|
| *1 | −18.7529 | 4.6414 | 1.53638 | 56.09 | 48.4 |
| *2 | −74.9352 | 5.4993 | | | 36.7 |
| 3 | 59.1891 | 0.8446 | 1.58913 | 61.25 | |
| 4 | 10.4117 | 6.6758 | | | |
| 5 | −30.9846 | 0.7587 | 1.51742 | 52.43 | |
| 6 | 9.3132 | 0.0849 | | | |
| 7 | 9.4265 | 5.9690 | 1.83481 | 42.72 | 15.1 |
| 8 | −217.9277 | 4.7350 | | | 13.6 |
| 9 | −8.0403 | 0.7587 | 1.80518 | 25.46 | |
| 10 | −40.2003 | 0.1680 | | | |
| *11 | 101.7193 | 5.7713 | 1.58313 | 59.38 | |
| *12 | −9.7068 | 0.1853 | | | |
| 13 | 132.5354 | 5.2605 | 1.49700 | 81.61 | |
| 14 | −18.5377 | 0.1694 | | | |
| 15 | 28.1594 | 6.6135 | 1.43700 | 95.10 | |
| 16 | −20.7690 | 0.0923 | | | |
| 17 | −20.2839 | 0.7588 | 1.84666 | 23.78 | |
| 18 | 90.7447 | 9.8312 | | | |
| 19 | 105.6652 | 4.9569 | 1.87070 | 40.73 | |
| 20 | −43.7126 | 1.2954 | | | |
| 21 | 20.7547 | 5.9933 | 1.80420 | 46.50 | |
| 22 | 77.8797 | 3.0352 | | | |
| 23 | −65.3179 | 0.8431 | 1.51680 | 64.20 | |
| 24 | 30.8569 | 12.9230 | | | |

TABLE 9B
Example 3

| Sn | R | D | Nd | νd |
|---|---|---|---|---|
| 25 | −16.5303 | 4.0399 | 1.51680 | 64.20 |
| 26 | 85.9226 | 4.7883 | | |
| 27 | −32.1354 | 3.7272 | 1.92286 | 20.88 |
| 28 | −21.4004 | 2.4356 | | |
| 29 | 65.3414 | 7.6625 | 1.77250 | 49.62 |
| 30 | −42.3548 | 5.8237 | | |
| 31 | 29.9440 | 0.8431 | 1.80518 | 25.46 |
| 32 | 22.2010 | DD[32] | | |
| 33 | 56.8775 | 2.1019 | 1.83481 | 42.72 |
| 34 | −123.5828 | DD[34] | | |
| 35 | 33.1923 | 0.7593 | 1.58144 | 40.75 |
| 36 | 21.5741 | 1.7664 | | |
| 37(St) | ∞ | 3.7200 | | |
| 38 | −19.5633 | 0.7165 | 1.84666 | 23.78 |
| 39 | 78.7194 | 0.1954 | | |
| 40 | 128.6381 | 3.7066 | 1.49700 | 81.61 |
| 41 | −21.6064 | 3.5243 | | |
| 42 | 70.7734 | 4.4661 | 1.49700 | 81.61 |
| 43 | −27.2081 | DD[43] | | |
| 44 | 41.8786 | 3.4214 | 1.92286 | 20.88 |
| 45 | ∞ | 11.4473 | | |
| 46 | ∞ | 26.5148 | 1.51680 | 64.20 |
| 47 | ∞ | 0.8637 | | |

TABLE 10
Example 3

| | WIDE | MIDDLE | TELE |
|---|---|---|---|
| Zr | 1.00 | 1.03 | 1.10 |
| \|f\| | 6.16 | 6.36 | 6.78 |
| Bf | 29.7 | 29.7 | 29.7 |
| FNo. | 1.82 | 1.84 | 1.90 |
| 2ω[°] | 116.4 | 114.8 | 111.6 |
| DD[32] | 24.24 | 22.52 | 19.27 |
| DD[34] | 4.81 | 5.45 | 7.50 |
| DD[43] | 15.09 | 16.17 | 17.38 |

TABLE 11
Example 3

| | | | |
|---|---|---|---|
| Projection Distance | 725.7 | 543.9 | 3628 |
| Spacing between | 9.8312 | 10.0113 | 9.3962 |
| Eighteenth Surface and | | | |
| Nineteenth Surface | | | |

TABLE 12
Example 3

| Sn | 1 | 2 |
|---|---|---|
| KA | −1.8787004E−01 | 1.5313982E+00 |
| A3 | −9.1118321E−04 | −8.6409839E−04 |
| A4 | 8.5423722E−04 | 8.0801519E−04 |
| A5 | −9.1328357E−05 | −8.0232637E−05 |
| A6 | 1.7766167E−06 | −2.3556420E−06 |
| A7 | 4.3643322E−07 | 1.1874251E−06 |
| A8 | −3.4098441E−08 | −7.6818452E−08 |
| A9 | −2.6398508E−10 | −3.6757191E−09 |
| A10 | 1.3153705E−10 | 6.1100310E−10 |
| A11 | −3.5507753E−12 | −4.9996608E−12 |
| A12 | −2.1542426E−13 | −2.1607291E−12 |
| A13 | 1.1784157E−14 | 6.6761497E−14 |
| A14 | 1.1149173E−16 | 3.7529017E−15 |
| A15 | −1.6512913E−17 | −1.7898112E−16 |
| A16 | 1.1183012E−19 | −2.9062684E−18 |
| A17 | 1.1226366E−20 | 2.1402386E−19 |
| A18 | −1.6840440E−22 | 6.5621714E−23 |
| A19 | −3.0399651E−24 | −9.7089875E−23 |
| A20 | 6.0908390E−26 | 7.5469033E−25 |

| Sn | 11 | 12 |
|---|---|---|
| KA | 1.0000000E+00 | 1.0000000E+00 |
| A3 | 0.0000000E+00 | 0.0000000E+00 |
| A4 | −1.0986039E−04 | 1.9591337E−05 |
| A5 | −7.0205425E−07 | 2.4738606E−05 |
| A6 | 5.3213325E−06 | −6.5949565E−06 |
| A7 | −7.7647293E−07 | 9.7780144E−07 |
| A8 | 4.0730189E−09 | −4.3271310E−09 |
| A9 | 8.7147527E−09 | −1.0858430E−08 |
| A10 | −6.1058642E−10 | 9.2662172E−10 |

### Example 4

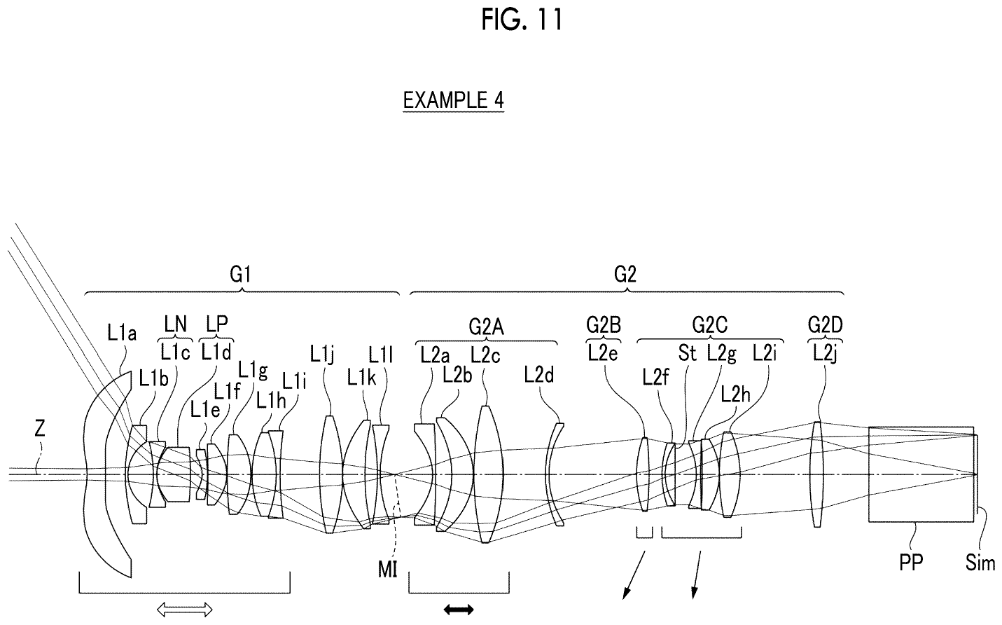

FIG. 11 shows a cross-sectional view of a configuration and luminous fluxes of a projection optical system according to Example 4. The projection optical system according to Example 4 consists of a first optical system G1 and a second optical system G2 in order from the enlargement side to the reduction side. The second optical system G2 consists of a second A lens group G2A having a positive power, a second B lens group G2B having a positive power, a second C lens group G2C having a negative power, and a second D lens group G2D having a positive power in order from the enlargement side to the reduction side. During changing magnification, the second A lens group G2A and the second D lens group G2D are fixed to the display surface Sim, and the second B lens group G2B and the second C lens group G2C move while changing a mutual spacing.

The first optical system G1 consists of lenses L1a to L1l in order from the enlargement side to the reduction side. The second A lens group G2A consists of lenses L2a to L2d in order from the enlargement side to the reduction side. The second B lens group G2B consists of a lens L2e. The second C lens group G2C consists of an aperture stop St, a lens L2f, and lenses L2g and L2i in order from the enlargement side to the reduction side. The second D lens group G2D consists of a lens L2j. The lens L1d corresponds to the P lens component LP, and the lens L1c corresponds to the N lens component LN. The focus group consists of lenses L1a to L1i. The back focus correction group consists of lenses L2a to L2c.

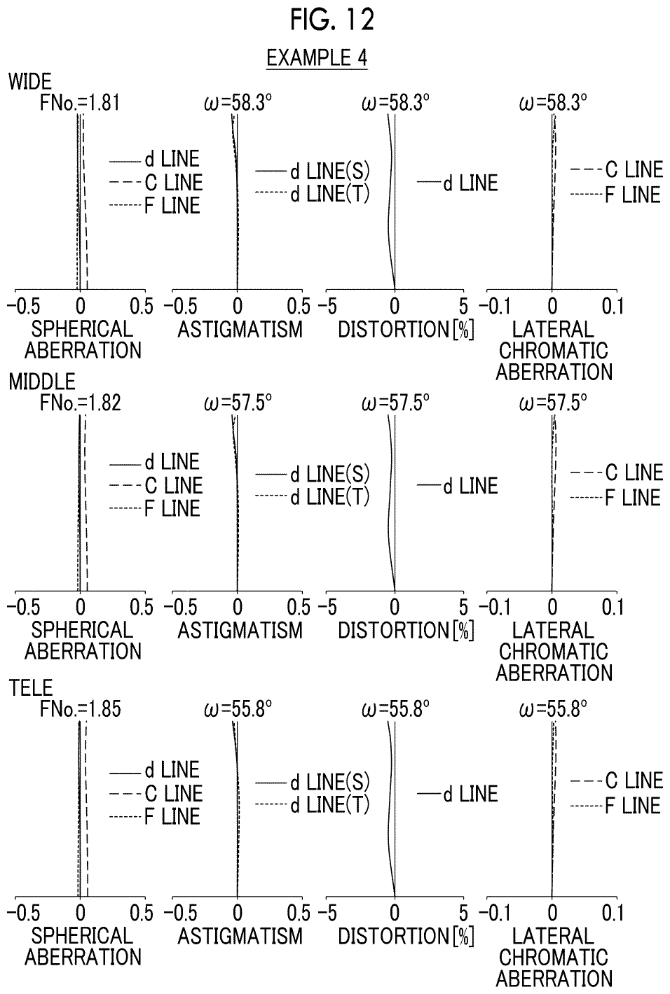

Regarding the projection optical system according to Example 4, Tables 13A and 13B show basic lens data, Table 14 shows specifications and variable surface spacings during changing magnification, Table 15 shows variable surface spacings during focusing, Table 16 shows aspherical coefficients, and FIG. 12 shows each of the aberration diagrams. Each of aberration diagrams is in a state where the projection distance is 725.7 millimeters (mm).

TABLE 13A
Example 4

| Sn | R | D | Nd | νd | ED |
|---|---|---|---|---|---|
| *1 | −18.7529 | 4.6413 | 1.53638 | 56.09 | 48.4 |
| *2 | −45.9924 | 4.8206 | | | 39.5 |
| 3 | 41.5916 | 0.8444 | 1.69680 | 55.53 | |
| 4 | 10.0089 | 6.4219 | | | |
| 5 | −30.0128 | 0.7602 | 1.53172 | 48.84 | |
| 6 | 12.0645 | 0.1685 | | | |
| 7 | 10.6030 | 8.4794 | 1.77250 | 49.60 | 14.9 |
| 8 | −65.5750 | 2.6069 | | | 10.9 |
| 9 | −8.5901 | 1.4513 | 1.80518 | 25.46 | |
| 10 | −51.0697 | 0.1680 | | | |
| *11 | −377.3223 | 4.7479 | 1.58313 | 59.38 | |
| *12 | −10.4166 | 0.1681 | | | |
| 13 | 125.5715 | 6.1503 | 1.49700 | 81.61 | |
| 14 | −15.2243 | 0.1693 | | | |
| 15 | 25.9137 | 6.0162 | 1.43700 | 95.10 | |
| 16 | −29.4194 | 0.0846 | | | |
| 17 | −28.4534 | 0.8432 | 1.84666 | 23.78 | |
| 18 | 56.6860 | 9.9589 | | | |
| 19 | 55.6880 | 5.7456 | 1.83481 | 42.74 | |
| 20 | −52.9663 | 0.1683 | | | |
| 21 | 20.1157 | 5.5405 | 1.83481 | 42.74 | |
| 22 | 57.2422 | 3.1866 | | | |
| 23 | −60.9309 | 0.8439 | 1.56883 | 56.36 | |
| 24 | 29.5783 | 13.1573 | | | |

TABLE 13B
Example 4

| Sn | R | D | Nd | νd |
|---|---|---|---|---|
| 25 | −14.8780 | 0.8447 | 1.65844 | 50.88 |
| 26 | −220.2393 | 3.8371 | | |
| 27 | −24.6129 | 5.4428 | 1.80518 | 25.46 |
| 28 | −18.0175 | 0.1688 | | |
| 29 | 68.4756 | 7.6306 | 1.77250 | 49.60 |
| 30 | −42.4780 | 10.2598 | | |
| 31 | 29.0945 | 1.0032 | 1.51742 | 52.43 |
| 32 | 21.2460 | DD[32] | | |
| 33 | 30.7203 | 2.9149 | 1.85883 | 30.00 |
| 34 | −2209.6345 | DD[34] | | |
| 35 | 22.6041 | 0.9073 | 1.60342 | 38.03 |
| 36 | 13.7945 | 2.5697 | | |
| 37(St) | ∞ | 5.5164 | | |
| 38 | −14.6378 | 0.7587 | 1.84666 | 23.78 |
| 39 | 72.2727 | 0.1021 | | |
| 40 | 87.7290 | 4.6591 | 1.49700 | 81.61 |
| 41 | −17.5434 | 0.1688 | | |
| 42 | 73.1826 | 5.4122 | 1.49700 | 81.61 |
| 43 | −21.2907 | DD[43] | | |
| 44 | 65.4735 | 3.7017 | 1.89286 | 20.36 |
| 45 | −106.9662 | 11.4473 | | |
| 46 | ∞ | 26.5148 | 1.51680 | 64.20 |
| 47 | ∞ | 0.8635 | | |

TABLE 14
Example 4

| | WIDE | MIDDLE | TELE |
|---|---|---|---|
| Zr | 1.00 | 1.03 | 1.10 |
| \|f\| | 6.16 | 6.36 | 6.77 |
| Bf | 29.7 | 29.7 | 29.7 |
| FNo. | 1.81 | 1.82 | 1.85 |
| 2ω[°] | 116.6 | 115.0 | 111.6 |
| DD[32] | 22.13 | 20.60 | 17.64 |
| DD[34] | 3.33 | 3.69 | 4.61 |
| DD[43] | 17.18 | 18.35 | 20.40 |

TABLE 15
Example 4

| | | | |
|---|---|---|---|
| Projection Distance | 725.7 | 543.9 | 3628 |
| Spacing between | 9.9589 | 10.1191 | 9.5715 |
| Eighteenth Surface and | | | |
| Nineteenth Surface | | | |

TABLE 16
Example 4

| Sn | 1 | 2 |
|---|---|---|
| KA | −5.5505211E−02 | 1.4214983E+00 |
| A3 | −7.9062797E−04 | −5.0269799E−04 |
| A4 | 7.7309963E−04 | 5.9927485E−04 |
| A5 | −7.3245100E−05 | −3.4381457E−05 |
| A6 | 7.2880349E−07 | −3.7122135E−06 |
| A7 | 3.4057845E−07 | 4.9029604E−07 |
| A8 | −2.0417666E−08 | −4.4417501E−09 |
| A9 | −3.7190726E−10 | −1.8983737E−09 |
| A10 | 7.4985121E−11 | 7.1110085E−11 |
| A11 | −1.3702913E−12 | 3.5919273E−12 |
| A12 | −1.1715042E−13 | −2.3594437E−13 |
| A13 | 4.8487810E−15 | −2.0591863E−15 |
| A14 | 6.8436160E−17 | 3.5573040E−16 |
| A15 | −6.3561781E−18 | −2.4949242E−18 |
| A16 | 2.5912812E−20 | −2.6393673E−19 |
| A17 | 3.9402657E−21 | 4.4735259E−21 |
| A18 | −5.0331553E−23 | 6.6318898E−23 |
| A19 | −9.6376125E−25 | −1.8494826E−24 |
| A20 | 1.7328343E−26 | 7.3938706E−27 |

| Sn | 11 | 12 |
|---|---|---|
| KA | 1.0000000E+00 | 1.0000000E+00 |
| A3 | 0.0000000E+00 | 0.0000000E+00 |
| A4 | −1.0260653E−04 | 4.6312625E−05 |
| A5 | −5.0338134E−06 | 3.0858106E−06 |
| A6 | 5.5082880E−06 | −2.4471839E−08 |
| A7 | −7.6033009E−07 | 1.0210004E−07 |
| A8 | −1.1234422E−08 | −1.0191542E−08 |
| A9 | 1.1115237E−08 | 1.6417956E−09 |
| A10 | −7.8390665E−10 | 9.0967586E−12 |

### Example 5

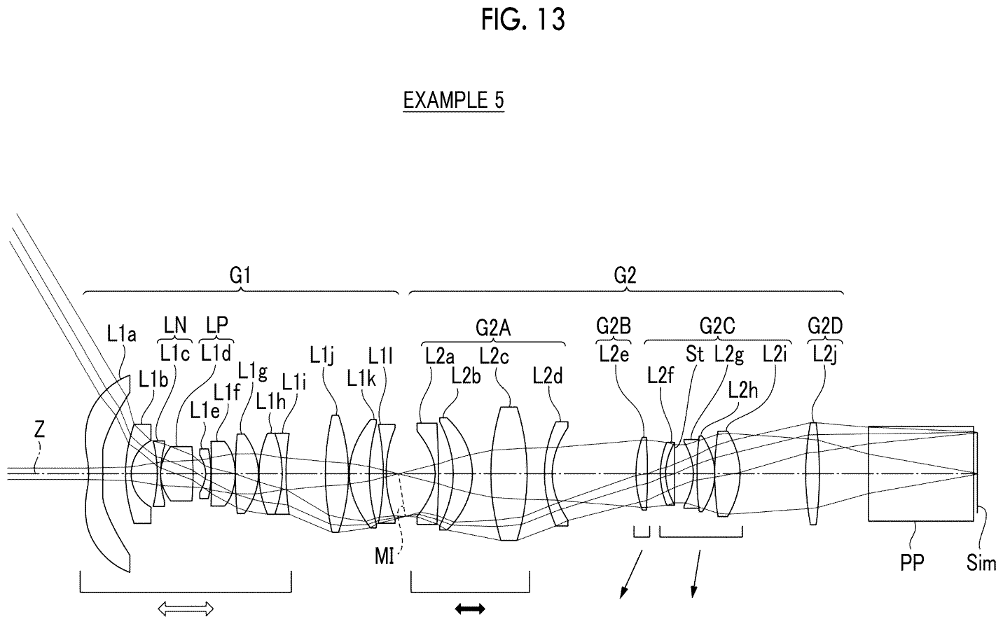

FIG. 13 shows a cross-sectional view of a configuration and luminous fluxes of a projection optical system according to Example 5. The projection optical system according to Example 5 consists of a first optical system G1 and a second optical system G2 in order from the enlargement side to the reduction side. The second optical system G2 consists of a second A lens group G2A having a positive power, a second B lens group G2B having a positive power, a second C lens group G2C having a negative power, and a second D lens group G2D having a positive power in order from the enlargement side to the reduction side. During changing magnification, the second A lens group G2A and the second D lens group G2D are fixed to the display surface Sim, and the second B lens group G2B and the second C lens group G2C move while changing a mutual spacing.

The first optical system G1 consists of lenses L1a to L1l in order from the enlargement side to the reduction side. The second A lens group G2A consists of lenses L2a to L2d in order from the enlargement side to the reduction side. The second B lens group G2B consists of a lens L2e. The second C lens group G2C consists of an aperture stop St, a lens L2f, and lenses L2g and L2i in order from the enlargement side to the reduction side. The second D lens group G2D consists of a lens L2j. The lens L1d corresponds to the P lens component LP, and the lens L1c corresponds to the N lens component LN. The focus group consists of lenses L1a to L1i. The back focus correction group consists of lenses L2a to L2c.

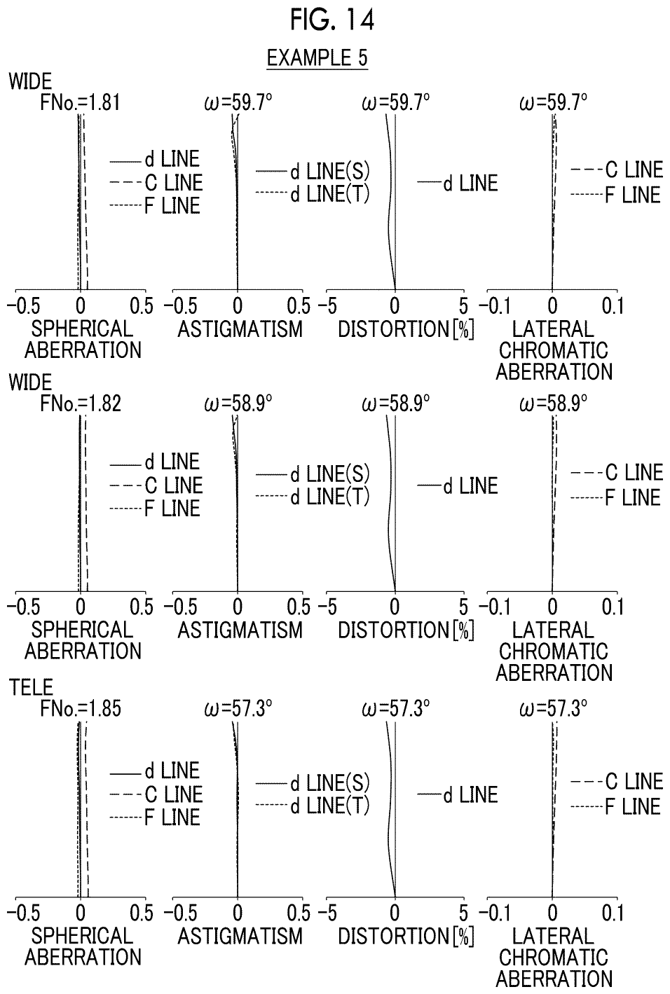

Regarding the projection optical system according to Example 5, Tables 17A and 17B show basic lens data, Table 18 shows specifications and variable surface spacings during changing magnification, Table 19 shows variable surface spacings during focusing, Table 20 shows aspherical coefficients, and FIG. 14 shows each of the aberration diagrams. Each of aberration diagrams is in a state where the projection distance is 688.0 millimeters (mm).

TABLE 17A
Example 5

| Sn | R | D | Nd | νd | ED |
|---|---|---|---|---|---|
| *1 | −18.0693 | 3.5099 | 1.51007 | 56.24 | 46.6 |
| *2 | −63.1966 | 5.6497 | | | 38.9 |
| 3 | 44.7407 | 1.4784 | 1.72916 | 54.68 | |
| 4 | 9.1611 | 6.4442 | | | |
| 5 | −24.4304 | 0.7193 | 1.56883 | 56.04 | |
| 6 | 24.4791 | 0.1607 | | | |
| 7 | 12.5601 | 7.9806 | 1.75500 | 52.32 | 14.1 |
| 8 | −46.6271 | 2.7921 | | | 10.2 |
| 9 | −9.1401 | 1.1468 | 1.80518 | 25.46 | |
| 10 | −67.4919 | 0.2028 | | | |
| *11 | 153.7799 | 5.9298 | 1.69350 | 53.18 | |
| *12 | −11.9751 | 0.1593 | | | |
| 13 | 160.6147 | 5.7221 | 1.49700 | 81.61 | |
| 14 | −15.0632 | 0.1593 | | | |
| 15 | 28.2997 | 5.4656 | 1.43700 | 95.10 | |
| 16 | −25.7093 | 0.0793 | | | |
| 17 | −24.9593 | 0.8001 | 1.84666 | 23.78 | |
| 18 | 41.9790 | 9.9304 | | | |
| 19 | 67.3894 | 5.5489 | 1.83481 | 42.74 | |
| 20 | −41.3789 | 0.1593 | | | |
| 21 | 18.4621 | 5.0133 | 1.83481 | 42.74 | |
| 22 | 38.5128 | 3.2926 | | | |
| 23 | −89.0488 | 0.7993 | 1.56883 | 56.36 | |
| 24 | 32.4373 | 12.0409 | | | |

TABLE 17B
Example 5

| Sn | R | D | Nd | νd |
|---|---|---|---|---|
| 25 | −14.9472 | 0.7999 | 1.65844 | 50.88 |
| 26 | −930.0538 | 3.6601 | | |
| 27 | −27.9393 | 5.0701 | 1.80518 | 25.46 |
| 28 | −17.2954 | 4.1034 | | |
| 29 | 48.7123 | 8.9971 | 1.77250 | 49.60 |
| 30 | −55.4501 | 4.3154 | | |
| 31 | 31.1599 | 1.7950 | 1.51742 | 52.43 |
| 32 | 20.1289 | DD[32] | | |
| 33 | 33.8199 | 2.4994 | 1.85883 | 30.00 |
| 34 | −524.3139 | DD[34] | | |
| 35 | 21.2094 | 1.3838 | 1.60342 | 38.03 |
| 36 | 13.2100 | 2.3248 | | |
| 37(St) | ∞ | 4.5182 | | |
| 38 | −13.4007 | 0.7199 | 1.84666 | 23.78 |
| 39 | 62.7408 | 0.0964 | | |
| 40 | 72.7421 | 4.2797 | 1.49700 | 81.61 |
| 41 | −16.2665 | 0.1667 | | |
| 42 | 78.3912 | 6.2723 | 1.49700 | 81.61 |
| 43 | −19.4246 | DD[43] | | |
| 44 | 66.9950 | 3.3066 | 1.89286 | 20.36 |
| 45 | −92.2606 | 12.0000 | | |
| 46 | ∞ | 26.4000 | 1.51680 | 64.20 |
| 47 | ∞ | 0.6573 | | |

TABLE 18
Example 5

| | WIDE | MIDDLE | TELE |
|---|---|---|---|
| Zr | 1.00 | 1.03 | 1.10 |
| \|f\| | 5.84 | 6.03 | 6.43 |
| Bf | 30.0 | 30.0 | 30.0 |
| FNo. | 1.81 | 1.82 | 1.85 |
| 2ω[°] | 119.4 | 117.8 | 114.6 |
| DD[32] | 20.84 | 19.29 | 16.28 |
| DD[34] | 3.29 | 3.74 | 4.84 |
| DD[43] | 16.07 | 17.19 | 19.10 |

TABLE 19
Example 5

| | | | |
|---|---|---|---|
| Projection Distance | 688 | 515.6 | 3439 |
| Spacing between | 9.9304 | 10.0724 | 9.5845 |
| Eighteenth Surface and | | | |
| Nineteenth Surface | | | |

TABLE 20
Example 5

| Sn | 1 | 2 |
|---|---|---|
| KA | −3.3664571E−02 | 3.1640446E+00 |
| A3 | −5.6352061E−04 | −1.1174484E−04 |
| A4 | 8.7985973E−04 | 6.0651289E−04 |
| A5 | −8.9890239E−05 | −3.6193407E−05 |
| A6 | 9.5236200E−07 | −4.1036821E−06 |
| A7 | 4.5831640E−07 | 5.0327319E−07 |
| A8 | −2.8385972E−08 | −1.2396621E−09 |
| A9 | −5.7165360E−10 | −2.0100873E−09 |
| A10 | 1.1434591E−10 | 5.9010667E−11 |
| A11 | −2.0865623E−12 | 4.0564013E−12 |
| A12 | −1.9673223E−13 | −2.0989892E−13 |
| A13 | 8.2883378E−15 | −3.0398125E−15 |
| A14 | 1.2834418E−16 | 3.2009653E−16 |
| A15 | −1.1975409E−17 | −1.3997371E−18 |
| A16 | 4.8018952E−20 | −2.3138308E−19 |
| A17 | 8.1584804E−21 | 3.8915599E−21 |
| A18 | −1.0819360E−22 | 4.6446445E−23 |
| A19 | −2.1909701E−24 | −1.7399115E−24 |
| A20 | 4.1151682E−26 | 1.3398597E−26 |

| Sn | 11 | 12 |
|---|---|---|
| KA | 1.0000000E+00 | 1.0000000E+00 |
| A3 | 0.0000000E+00 | 0.0000000E+00 |
| A4 | −1.1251467E−04 | 3.8542975E−05 |
| A5 | −1.0309803E−05 | 4.8273273E−06 |
| A6 | 6.8515993E−06 | 6.0099695E−08 |
| A7 | −9.3111160E−07 | −6.0187951E−08 |
| A8 | −2.3040939E−08 | 1.9229409E−09 |
| A9 | 1.5077886E−08 | 2.5803675E−09 |
| A10 | −1.1062772E−09 | −2.1582100E−10 |

### Example 6

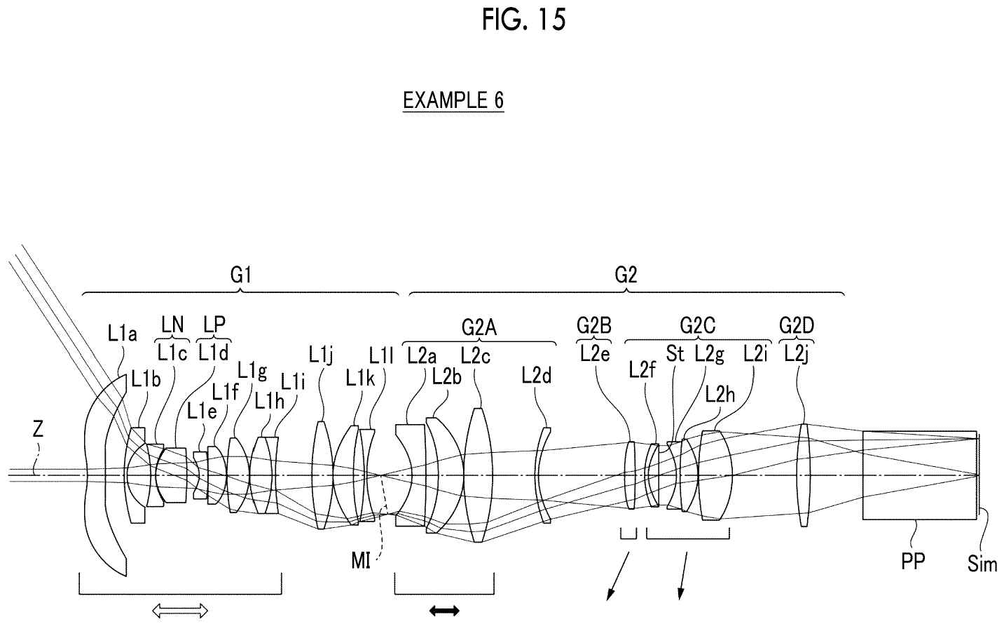

FIG. 15 shows a cross-sectional view of a configuration and luminous fluxes of a projection optical system according to Example 6. The projection optical system according to Example 6 consists of a first optical system G1 and a second optical system G2 in order from the enlargement side to the reduction side. The second optical system G2 consists of a second A lens group G2A having a positive power, a second B lens group G2B having a positive power, a second C lens group G2C having a negative power, and a second D lens group G2D having a positive power in order from the enlargement side to the reduction side. During changing magnification, the second A lens group G2A and the second D lens group G2D are fixed to the display surface Sim, and the second B lens group G2B and the second C lens group G2C move while changing a mutual spacing.

The first optical system G1 consists of lenses L1a to L1l in order from the enlargement side to the reduction side. The second A lens group G2A consists of lenses L2a to L2d in order from the enlargement side to the reduction side. The second B lens group G2B consists of a lens L2e. The second C lens group G2C consists of an aperture stop St, a lens L2f, and lenses L2g and L2i in order from the enlargement side to the reduction side. The second D lens group G2D consists of a lens L2j. The lens L1d corresponds to the P lens component LP, and the lens L1c corresponds to the N lens component LN. The focus group consists of lenses L1a to L1i. The back focus correction group consists of lenses L2a to L2c.

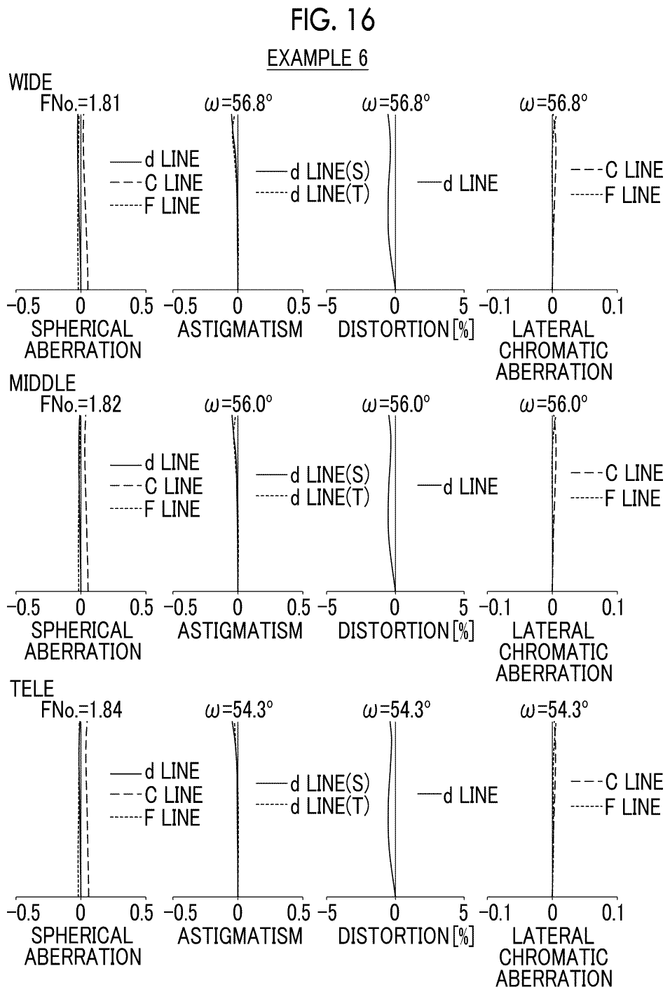

Regarding the projection optical system according to Example 6, Tables 21A and 21B show basic lens data, Table 22 shows specifications and variable surface spacings during changing magnification, Table 23 shows variable surface spacings during focusing, Table 24 shows aspherical coefficients, and FIG. 16 shows each of the aberration diagrams. Each of aberration diagrams is in a state where the projection distance is 767.9 millimeters (mm).

TABLE 21A
Example 6

| Sn | R | D | Nd | νd | ED |
|---|---|---|---|---|---|
| *1 | −19.8413 | 4.9115 | 1.53638 | 56.09 | 50.40 |
| *2 | −37.1157 | 4.8792 | | | 42.2 |
| 3 | 48.4630 | 0.8921 | 1.69680 | 55.53 | |
| 4 | 10.3833 | 6.5963 | | | |
| 5 | −29.6917 | 1.2374 | 1.53172 | 48.84 | |
| 6 | 13.8968 | 0.1790 | | | |
| 7 | 11.6435 | 8.3779 | 1.77250 | 49.60 | 14.80 |
| 8 | −57.1870 | 2.8441 | | | 10.8 |
| 9 | −9.3683 | 2.7262 | 1.80518 | 25.46 | |
| 10 | −64.1961 | 0.1778 | | | |
| *11 | 398.2368 | 4.9200 | 1.58313 | 59.38 | |
| *12 | −11.3729 | 0.1778 | | | |
| 13 | 55.3554 | 6.0007 | 1.49700 | 81.61 | |
| 14 | −17.6023 | 0.1791 | | | |
| 15 | 30.6413 | 5.8925 | 1.43700 | 95.10 | |
| 16 | −25.4077 | 0.0885 | | | |
| 17 | −24.6259 | 0.8921 | 1.84666 | 23.78 | |
| 18 | 53.9894 | 9.9672 | | | |
| 19 | 62.2918 | 5.6254 | 1.83481 | 42.74 | |
| 20 | −49.4798 | 0.1778 | | | |
| 21 | 21.3038 | 5.5466 | 1.83481 | 42.74 | |
| 22 | 72.8487 | 2.6758 | | | |
| 23 | −72.9490 | 0.8928 | 1.56883 | 56.36 | |
| 24 | 31.3676 | 12.3666 | | | |

TABLE 21B
Example 6

| Sn | R | D | Nd | νd |
|---|---|---|---|---|
| 25 | −14.9712 | 3.5831 | 1.65844 | 50.88 |
| 26 | −354.6401 | 3.4735 | | |
| 27 | −32.1423 | 6.8878 | 1.80518 | 25.46 |
| 28 | −20.3465 | 0.1786 | | |
| 29 | 59.2601 | 7.8967 | 1.77250 | 49.60 |
| 30 | −55.2274 | 11.3794 | | |
| 31 | 34.6065 | 0.8933 | 1.51742 | 52.43 |
| 32 | 23.1253 | DD[32] | | |
| 33 | 38.5640 | 2.8756 | 1.85883 | 30.00 |
| 34 | −247.4082 | DD[34] | | |
| 35 | 26.7581 | 0.9202 | 1.60342 | 38.03 |
| 36 | 15.1388 | 3.0575 | | |
| 37(St) | ∞ | 4.3753 | | |
| 38 | −14.3702 | 0.8028 | 1.84666 | 23.78 |
| 39 | 73.7157 | 0.1076 | | |
| 40 | 88.9363 | 5.1425 | 1.49700 | 81.61 |
| 41 | −17.0864 | 0.1781 | | |
| 42 | 90.1976 | 9.1844 | 1.49700 | 81.61 |
| 43 | −22.2561 | DD[43] | | |
| 44 | 72.3664 | 3.7583 | 1.89286 | 20.36 |
| 45 | −118.2609 | 14.2857 | | |
| 46 | ∞ | 31.2500 | 1.51680 | 64.20 |
| 47 | ∞ | 0.5540 | | |

TABLE 22
Example 6

| | WIDE | MIDDLE | TELE |
|---|---|---|---|
| Zr | 1.00 | 1.03 | 1.10 |
| \|f\| | 6.52 | 6.73 | 7.17 |
| Bf | 35.4 | 35.4 | 35.4 |
| FNo. | 1.81 | 1.82 | 1.84 |
| 2ω[°] | 113.6 | 112.0 | 108.6 |
| DD[32] | 23.48 | 21.81 | 18.59 |
| DD[34] | 2.91 | 3.43 | 4.68 |
| DD[43] | 17.14 | 18.29 | 20.26 |

TABLE 23
Example 6

| | | | |
|---|---|---|---|
| Projection Distance | 767.9 | 5754 | 3839 |
| Spacing between | 9.9672 | 10.1191 | 9.5989 |
| Eighteenth Surface and | | | |
| Nineteenth Surface | | | |

TABLE 24
Example 6

| Sn | 1 | 2 |
|---|---|---|
| KA | −2.2155115E−01 | 9.1384947E−01 |
| A3 | −6.8085845E−04 | −4.7069615E−04 |
| A4 | 6.0485741E−04 | 4.8967050E−04 |
| A5 | −5.2622833E−05 | −2.6678002E−05 |
| A6 | 4.4612404E−07 | −2.5899908E−06 |
| A7 | 2.1120462E−07 | 3.3815845E−07 |
| A8 | −1.1524238E−08 | −3.9687203E−09 |
| A9 | −2.0459223E−10 | −1.1513241E−09 |
| A10 | 3.6527824E−11 | 4.6191067E−11 |
| A11 | −6.0022202E−13 | 1.8817211E−12 |
| A12 | −4.9174314E−14 | −1.3624062E−13 |
| A13 | 1.8553599E−15 | −7.9426040E−16 |
| A14 | 2.4922922E−17 | 1.9071456E−16 |
| A15 | −2.0951898E−18 | −1.3632834E−18 |
| A16 | 7.6516719E−21 | −1.3962802E−19 |
| A17 | 1.1161753E−21 | 1.9196361E−21 |
| A18 | −1.3151802E−23 | 4.4638214E−23 |
| A19 | −2.3441752E−25 | −6.8897781E−25 |
| A20 | 3.9019600E−27 | −3.1915522E−27 |

| Sn | 11 | 12 |
|---|---|---|
| KA | 1.0000000E+00 | 1.0000000E+00 |
| A3 | −5.7261720E−20 | 6.6477620E−20 |
| A4 | −8.0343091E−05 | 3.3315776E−05 |
| A5 | −1.1706655E−05 | 9.5520850E−07 |
| A6 | 5.3221192E−06 | 2.9410315E−07 |
| A7 | −5.9171762E−07 | −5.5012370E−09 |
| A8 | −2.4500854E−08 | −4.5901039E−09 |
| A9 | 9.2842951E−09 | 1.7356234E−09 |
| A10 | −5.5077917E−10 | −1.0121243E−10 |

Regarding the projection optical systems according to Examples 1 to 6, Table 25 shows the values of Ymax, Y55, Y50, Y40, and pL1, and Table 26 shows the corresponding values of Conditional Expressions (1) to (20). The corresponding values of Conditional Expressions (13), (14), and (17) to (20) are values in a state where the magnification of the projection optical system is 120-fold. In the projection optical system according to the present disclosure, the use at a magnification of 50-fold or higher (that is, the lateral magnification of the entire projection optical system is 0.02 or less) is assumed. Preferable ranges of the conditional expressions may be set by using the corresponding values of the examples shown in Table 26 as the upper limits or the lower limits of the conditional expressions.

TABLE 25

| | Exam- | Exam- | Exam- | Exam- | Exam- | Exam- |
|---|---|---|---|---|---|---|
| | ple 1 | ple 2 | ple 3 | ple 4 | ple 5 | ple 6 |
| Ymax | 10 | 10 | 10 | 10 | 10 | 10 |
| Y55 | 8.83 | 8.80 | 8.85 | 8.82 | 8.34 | 9.34 |
| Y50 | 7.36 | 7.33 | 7.38 | 7.35 | 6.96 | 7.78 |
| Y40 | 5.16 | 5.15 | 5.18 | 5.17 | 4.90 | 5.46 |
| ρL1 | 1.03 | 1.03 | 1.03 | 1.03 | 1.01 | 1.03 |

TABLE 26

| Expression | | | | | | | |
|---|---|---|---|---|---|---|---|
| Number | | Example 1 | Example 2 | Example 3 | Example 4 | Example 5 | Example 6 |
| (1) | Zp/Ymax | 1.9 | 1.9 | 1.9 | 1.8 | 1.8 | 1.9 |
| (2) | Rpf/Ymax | 1.62 | 1.38 | 0.94 | 1.06 | 1.26 | 1.16 |
| (3) | Rnr/Ymax | 1.58 | 1.35 | 0.93 | 1.21 | 2.45 | 1.39 |
| (4) | Bf/Ymax | 2.97 | 2.97 | 2.97 | 2.97 | 3.00 | 3.54 |
| (5) | Y50/Y40 | 1.425 | 1.424 | 1.424 | 1.423 | 1.421 | 1.425 |
| (5A) | Y55/Y40 | 1.710 | 1.709 | 1.709 | 1.707 | 1.704 | 1.710 |
| (6) | Dnp/Ymax | 0.008 | 0.008 | 0.008 | 0.017 | 0.016 | 0.018 |
| (7) | (Rpr + Rpf)/ | 0.390 | 0.536 | 0.917 | 0.722 | 0.576 | 0.662 |
| | (Rpr − Rpf) | | | | | | |
| (8) | EDp/Ymax | 1.670 | 1.560 | 1.510 | 1.490 | 1.410 | 1.480 |
| (9) | (Rnr + Rnf)/ | −0.269 | −0.352 | −0.538 | −0.427 | 0.001 | −0.362 |
| | (Rnr − Rnf) | | | | | | |
| (10) | dAmax/Ymax | 1.32 | 1.26 | 1.29 | 1.32 | 1.20 | 1.24 |
| (11) | f2B/\|f2C\| | 0.11 | 0.10 | 0.09 | 0.02 | 0.02 | 0.01 |
| (12) | EDL1 × ρL1/Ymax | 5.22 | 4.99 | 4.99 | 4.99 | 4.71 | 5.19 |
| (13) | (1-βF²) × βFr² | 0.095 | 0.098 | 0.097 | 0.108 | 0.115 | 0.121 |
| (14) | ((1-BF²) × βFr²)/ | 0.29 | 0.29 | 0.28 | 0.28 | 0.28 | 0.28 |
| | ΔtF | | | | | | |
| (15) | dFr12/Ymax | 0.000 | 0.000 | 0.009 | 0.008 | 0.008 | 0.009 |
| (16) | ZFBr/\|f\| | 11.0 | 10.7 | 10.4 | 17.1 | 18.5 | 16.9 |
| (17) | (1-βFF²) × βFFr² | 0.095 | 0.098 | 0.097 | 0.108 | 0.115 | 0.121 |
| (18) | \|(1-βB²) × βBr²\| | 0.287 | 0.322 | 0.281 | 0.722 | 0.770 | 0.735 |
| (19) | \|(1-βB²) × βBr²\|/ | 1.05 | 0.95 | 0.99 | 0.85 | 0.90 | 0.82 |
| | ΔtB | | | | | | |
| (20) | ((1-βFF²) × βFFr²)/ | 0.29 | 0.29 | 0.28 | 0.28 | 0.28 | 0.28 |
| | ΔtFF | | | | | | |

The projection optical systems according to Examples 1 to 6 have a wide angle of view which is a total angle of view of 110 degrees or more at the wide-angle end. The projection optical systems according to Examples 1 to 6 each have a small F number which is less than 2. Further, the projection optical systems according to Examples 1 to 6 are configured to be small while having a long back focus, and achieve high optical performance by satisfactorily correcting various aberrations.

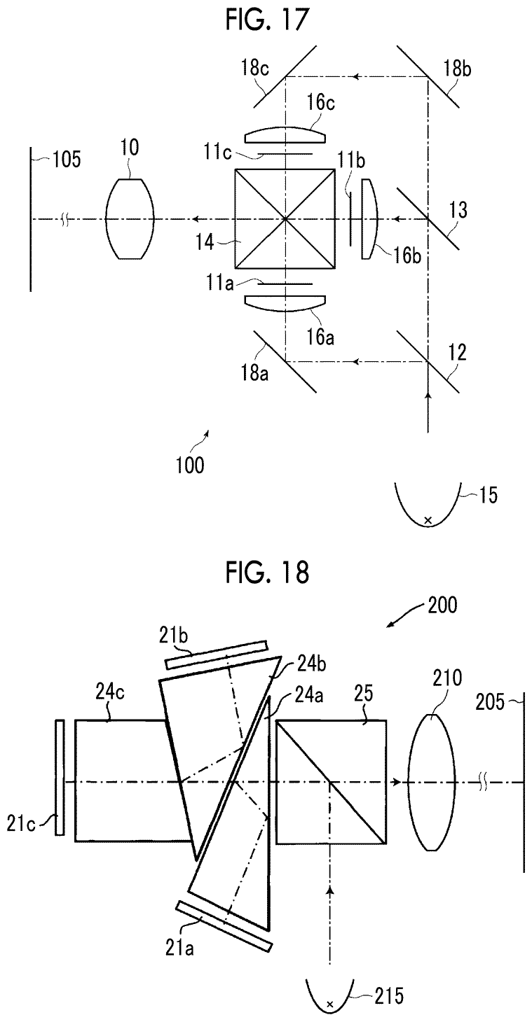

Next, a projection type display device according to an embodiment of the present disclosure will be described. FIG. 17 is a schematic configuration diagram showing the projection type display device according to the embodiment of the present disclosure. The projection type display device 100 shown in FIG. 17 includes a projection optical system 10 according to an embodiment of the present disclosure, a light source 15, and transmissive display elements 11a to 11c as light valves corresponding to colored rays and outputting optical images. Further, the projection type display device 100 includes dichroic mirrors 12 and 13 for color separation, a cross dichroic prism 14 for color synthesis, condenser lenses 16a to 16c, and total reflection mirrors 18a to 18c for deflecting the optical path. It should be noted that FIG. 17 schematically shows the projection optical system 10. Further, an integrator is disposed between the light source 15 and the dichroic mirror 12, but is not shown in FIG. 17.

White light emitted from the light source 15 is separated into three colored luminous fluxes (green light, blue light, and red light) through the dichroic mirrors 12 and 13. Next, the three colored luminous fluxes pass through the condenser lenses 16a to 16c, are incident on and modulated by the transmissive display elements 11a to 11c respectively corresponding to the respective colored luminous fluxes, are subjected to color synthesis by the cross dichroic prism 14, and are subsequently incident on the projection optical system 10. The projection optical system 10 projects an optical image based on the modulated light modulated by the transmissive display elements 11a to 11c onto a screen 105.

FIG. 18 is a schematic configuration diagram showing a projection type display device according to another embodiment of the present disclosure. A projection type display device 200 shown in FIG. 18 includes a projection optical system 210 according to an embodiment of the present disclosure, a light source 215, and digital micromirror device (DMD: registered trademark) elements 21a to 21c as light valves corresponding to respective colored rays and outputting optical images. Further, the projection type display device 200 includes total internal reflection (TIR) prisms 24a to 24c for color separation and color synthesis, and a polarization separating prism 25 that separates illumination light and projection light. It should be noted that FIG. 18 schematically shows the projection optical system 210. In addition, an integrator is disposed between the light source 215 and the polarization separating prism 25, but is not shown in FIG. 18.

White light emitted from the light source 215 is reflected from a reflecting surface inside the polarization separating prism 25, and is separated into three colored luminous fluxes (green light, blue light, and red light) by the TIR prisms 24a to 24c. The separated colored luminous fluxes are respectively incident on and modulated by the corresponding DMD elements 21a to 21c, travel through the TIR prisms 24a to 24c again in the opposite direction, are subjected to color synthesis, subsequently transmit through the polarization separating prism 25, and are incident on the projection optical system 210. The projection optical system 210 projects an optical image based on the modulated light modulated by the DMD elements 21a to 21c onto a screen 205.

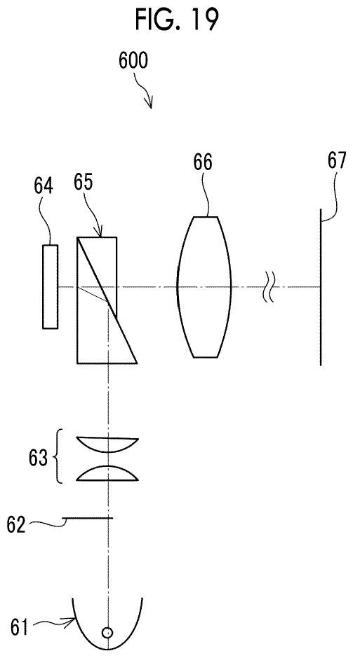

FIG. 19 is a schematic configuration diagram showing a projection type display device according to still another embodiment of the present disclosure. The projection type display device 600 shown in FIG. 19 includes a projection optical system 66 according to an embodiment of the present disclosure, a light source 61, and a DMD element 64 as a light valve corresponding to a colored ray and outputting an optical image. Further, the projection type display device 600 includes a color wheel 62, a light guide optical system 63, and a TIR prism 65. It should be noted that FIG. 19 schematically shows the projection optical system 66.

Filters having three colors of green, blue, and red are provided on a circumference of the color wheel 62. In a case where the color wheel 62 is rotated, the filters having the respective colors are sequentially inserted on the optical path. White light from the light source 61 is incident on the rotating color wheel 62 and is time-divided into luminous flux having three colors (green light, blue light, and red light). The luminous fluxes having the respective colors after the time-division pass through the light guide optical system 63 and the TIR prism 65, are incident on the DMD elements 64 to be modulated, and are incident on the projection optical system 66 through the TIR prism 65 again. The projection optical system 66 projects an optical image based on the modulated light modulated by the DMD element 64 onto a screen 67.

The present disclosed technology has been hitherto described through embodiments and examples, but the technique of the present disclosure is not limited to the above-mentioned embodiments and examples, and may be modified into various forms. For example, the curvature radius, the surface spacing, the refractive index, the Abbe number, the aspherical coefficient, and the like of each of the lenses are not limited to the values shown in the examples, and different values may be used therefor.

Further, the projection type display device according to the present disclosed technology is not limited to the above-described configuration, and may be modified into various aspects such as the optical member used for luminous flux separation or luminous flux synthesis and the light valve. The light valve is not limited to a form in which light emitted from the light source is spatially modulated by an image display element and is output as an optical image based on image data, but may be a form in which light itself output from a light emitting image display element is output as an optical image based on the image data.

Examples of the light emitting image display element include an image display element where light emitting elements such as light emitting diodes (LED) or organic light emitting diodes (OLED) are two-dimensionally arranged. The light valve is not limited to the three-plate type, and may be a single-plate type. By adopting a configuration in which the light valve corresponds to the single-plate type, it is possible to achieve a reduction in size of the optical engine.

Regarding the above-described embodiments and examples, the following supplementary notes will be further disclosed.

### Supplementary Note 1

A projection optical system that projects an image on a reduction-side imaging plane onto an enlargement-side imaging plane,
in which a half angle of view on an enlargement side is 50 degrees or more,
in a case where one lens component is one single lens or one cemented lens, the projection optical system includes a P lens component that is a lens component having a positive power and closest to the enlargement side among lens components in the projection optical system and an N lens component that is a lens component having a negative power and disposed adjacent to the enlargement side of the P lens component, and
in a case where a maximum image height on the reduction-side imaging plane is represented by Ymax,
a distance on an optical axis from a surface of an optical element having a power closest to the enlargement side in the projection optical system to a lens surface closest to the enlargement side in the P lens component is represented by Zp,
a curvature radius of the lens surface closest to the enlargement side in the P lens component is represented by Rpf,
a curvature radius of a lens surface closest to the reduction side in the N lens component is represented by Rnr,
a back focus of the projection optical system on the reduction side in terms of an air conversion distance is represented by Bf,
an image height on the reduction-side imaging plane of a ray having a half angle of view of 40 degrees on the enlargement side is represented by Y40,
an image height on the reduction-side imaging plane of a ray having a half angle of view of 50 degrees on the enlargement side is represented by Y50, and
Ymax, Zp, Bf, Y40, and Y50 are values at a wide-angle end in a case where the projection optical system is a variable magnification optical system,
Conditional Expressions (1), (2), (3), (4), and (5) represented by

$$\begin{matrix}1 < Zp / Y max < 4 , & ( 1 ) \\ 0.2 < Rpf / Y max < 2.3 , & ( 2 ) \\ 0.2 < Rnr / Y max < 5 , & ( 3 ) \\ 2 < Bf / Y max < 8 , and & ( 4 ) \\ 1.35 < Y 50 / Y 40 < 1.5 & ( 5 )\end{matrix}$$

are satisfied.

### Supplementary Note 2

The projection optical system according to Supplementary Note 1, consisting of a first optical system and a second optical system along an optical path in order from the enlargement side to the reduction side,
in which the second optical system forms an intermediate image at a position conjugate to the reduction-side imaging plane between the first optical system and the second optical system, and the first optical system re-forms the intermediate image on the enlargement-side imaging plane.

### Supplementary Note 3

The projection optical system according to Supplementary Note 1 or 2,
in which in a case where a spacing on the optical axis between the N lens component and the P lens component is represented by Dnp, and
Dnp is a value at the wide-angle end in a case where the projection optical system is a variable magnification optical system,
Conditional Expression (6) represented by

$$0 < Dnp / Y max < 0.1 \qquad ( 6 )$$

is satisfied.

### Supplementary Note 4

The projection optical system according to any one of Supplementary Notes 1 to 3,
in which in a case where a curvature radius of a lens surface closest to the reduction side in the P lens component is represented by Rpr,
Conditional Expression (7) represented by

$$0 < ( Rpr + Rpf ) / ( Rpr - Rpf ) < 2 \qquad ( 7 )$$

is satisfied.

### Supplementary Note 5

The projection optical system according to any one of Supplementary Notes 1 to 4,
in which in a case where a larger value among a maximum effective diameter of the lens surface closest to the enlargement side in the P lens component and a maximum effective diameter of the lens surface closest to the reduction side in the P lens component is represented by EDp,
Conditional Expression (8) represented by

$$0.5 < EDp / Y max < 2.5 \qquad ( 8 )$$

is satisfied.

### Supplementary Note 6

The projection optical system according to any one of Supplementary Notes 1 to 5,
in which in a case where a curvature radius of a lens surface closest to the enlargement side in the N lens component is represented by Rnf,
Conditional Expression (9) represented by

$$- 1 < ( Rnr + Rnf ) / ( Rnr - Rnf ) < 0.5 \qquad ( 9 )$$

is satisfied.

### Supplementary Note 7

The projection optical system according to Supplementary Note 2,
in which the projection optical system is a zoom lens including movable lens groups that move during changing magnification in the second optical system,
a group consisting of all of lenses closer to the enlargement side than the movable lens group closest to the enlargement side among the movable lens groups in the projection optical system is an enlargement-side stationary group, and
in a case where a longest air spacing between lens surfaces on the optical axis in the enlargement-side stationary group at the wide-angle end is represented by dAmax,
Conditional Expression (10) represented by

$$0.2 < dA max / Y max < 2.5 \qquad ( 10 )$$

is satisfied.

### Supplementary Note 8

The projection optical system according to Supplementary Note 2 or 7,
in which the projection optical system is a zoom lens,
in a case where one lens group is a group of which a spacing to an adjacent group in an optical axis direction changes during changing magnification in the second optical system,
the second optical system consists of a second A lens group, a second B lens group, a second C lens group, and a second D lens group along the optical path in order from the enlargement side to the reduction side, and
during changing magnification, the second A lens group and the second D lens group are fixed to the reduction-side imaging plane, and the second B lens group and the second C lens group move while changing a mutual spacing.

### Supplementary Note 9

The projection optical system according to Supplementary Note 8,
in which in a case where a focal length of the second B lens group is represented by f2B, and
a focal length of the second C lens group is represented by f2C,
Conditional Expression (11) represented by

$$0 < f 2 B / \vert f 2 C \vert < 0.5 \qquad ( 11 )$$

is satisfied.

### Supplementary Note 10

The projection optical system according to any one of Supplementary Notes 1 to 9,
in which in a case where a larger value among a maximum effective diameter of an enlargement-side surface of a lens closest to the enlargement side in the projection optical system and a maximum effective diameter of a reduction-side surface of the lens closest to the enlargement side in the projection optical system is represented by EDL1, and
a specific gravity of the lens closest to the enlargement side in the projection optical system is represented by pL1,
Conditional Expression (12) represented by

$$0.5 < EDL 1 \times ρ L 1 / Y max < 10 \qquad ( 12 )$$

is satisfied.

### Supplementary Note 11

The projection optical system according to any one of Supplementary Notes 1 to 10,
in which the P lens component is a single lens, and a refractive index of the P lens component with respect to a d line is 1.65 or more.

### Supplementary Note 12

The projection optical system according to Supplementary Note 11,
in which the N lens component is a single lens, and
a refractive index of the N lens component with respect to the d line is 1.65 or less.

### Supplementary Note 13

The projection optical system according to Supplementary Note 2,
in which the first optical system includes an aspherical lens.

### Supplementary Note 14

The projection optical system according to Supplementary Note 13,
in which the first optical system includes two aspherical lenses.

### Supplementary Note 15

The projection optical system according to Supplementary Note 13 or 14,
in which a lens surface closest to the enlargement side in the first optical system is an aspherical surface that has a concave surface facing the enlargement side in a paraxial region and has an inflection point where an uneven shape changes halfway from the optical axis toward a peripheral portion.

### Supplementary Note 16

The projection optical system according to any one of Supplementary Notes 1 to 15,
in which the reduction side is telecentric.

### Supplementary Note 17

A projection type display device comprising:
the projection optical system according to any one of Supplementary Notes 1 to 16.

### Supplementary Note 18

A projection optical system consisting of a first optical system and a second optical system along an optical path in order from an enlargement side to a reduction side,
in which the second optical system forms an intermediate image at a position conjugate to a reduction-side imaging plane between the first optical system and the second optical system, and the first optical system re-forms the intermediate image on an enlargement-side imaging plane,
a focus group that includes six or more lenses and performs focus adjustment of an entire image plane in a case where a projection distance changes by moving along the optical axis is disposed closest to the enlargement side in the projection optical system, and
all of lens spacings in the focus group are invariable during the focus adjustment.

### Supplementary Note 19

The projection optical system according to Supplementary Note 18,
in which the focus group is disposed in the first optical system.

### Supplementary Note 20

The projection optical system according to Supplementary Note 18 or 19,
in which a paraxial lateral magnification of the focus group is represented by βF,
a combined paraxial lateral magnification of all of lenses closer to the reduction side than the focus group is represented by βFr, and
βF and βFr are values at a wide-angle end in a case where the projection optical system is a variable magnification optical system,
Conditional Expression (13) represented by

$$0.02 < ( 1 - β {F}^{2} ) \times β F {r}^{2} < 0.2 \qquad ( 13 )$$

is satisfied.

### Supplementary Note 21

The projection optical system according to any one of Supplementary Notes 18 to 20,
in which a paraxial lateral magnification of the focus group is represented by βF,
a combined paraxial lateral magnification of all of lenses closer to the reduction side than the focus group is represented by βFr,
a maximum image height on the reduction-side imaging plane is represented by Ymax,
an amount of change in an optical axis direction of a tangential image plane at a half angle of view of 50 degrees during movement of the focus group by 0.1×Ymax in the optical axis direction is represented by ΔtF, and
βF, βFr, Ymax, and ΔtF are values at a wide-angle end in a case where the projection optical system is a variable magnification optical system,
Conditional Expression (14) represented by

$$0.1 < ( ( 1 - β {F}^{2} ) \times β F {r}^{2} ) / Δ tF < 0.5 \qquad ( 14 )$$

is satisfied.

### Supplementary Note 22

The projection optical system according to any one of Supplementary Notes 18 to 21,
in which the focus group includes two or more positive lenses.

### Supplementary Note 23

The projection optical system according to any one of Supplementary Notes 18 to 22,
in which a lens surface closest to the enlargement side in the focus group is an aspherical surface that has a concave surface facing the enlargement side in a paraxial region and has an inflection point where an uneven shape changes halfway from the optical axis toward a peripheral portion.

### Supplementary Note 24

The projection optical system according to any one of Supplementary Notes 18 to 23,
in which among a first lens from the reduction side of the focus group and a second lens from the reduction side of the focus group, one lens is a positive lens and the other lens is a negative lens, and
in a case where a spacing on the optical axis between the first lens from the reduction side of the focus group and the second lens from the reduction side of the focus group is represented by dFr12,
a maximum image height on the reduction-side imaging plane is represented by Ymax, and
Ymax is a value at a wide-angle end in a case where the projection optical system is a variable magnification optical system,
Conditional Expression (15) represented by

$$0 \leq dFr 12 / Y max < 0.1 \qquad ( 15 )$$

is satisfied.

### Supplementary Note 25

The projection optical system according to any one of Supplementary Notes 18 to 24,
in which a back focus correction group that performs back focus adjustment by moving along the optical axis is disposed.

### Supplementary Note 26

The projection optical system according to any one of Supplementary Notes 18 to 25,
in which the projection optical system is a zoom lens including movable lens groups that move during changing magnification in the second optical system,
a group consisting of all of lenses closer to the enlargement side than the movable lens group closest to the enlargement side among the movable lens groups in the projection optical system is an enlargement-side stationary group, and
in a case where a longest air spacing between lens surfaces on the optical axis in the enlargement-side stationary group at a wide-angle end is represented by dAmax,
Conditional Expression (10) represented by

$$0.2 < dA max / Y max < 2.5 \qquad ( 10 )$$

is satisfied.

### Supplementary Note 27

The projection optical system according to any one of Supplementary Notes 18 to 26,
in which the projection optical system is a zoom lens,
in a case where one lens group is a group of which a spacing to an adjacent group in an optical axis direction changes during changing magnification in the second optical system,
the second optical system consists of a second A lens group, a second B lens group, a second C lens group, and a second D lens group along the optical path in order from the enlargement side to the reduction side, and
during changing magnification, the second A lens group and the second D lens group are fixed to the reduction-side imaging plane, and the second B lens group and the second C lens group move while changing a mutual spacing.

### Supplementary Note 28

The projection optical system according to Supplementary Note 27,
in which in a case where a focal length of the second B lens group is represented by f2B, and
a focal length of the second C lens group is represented by f2C,
Conditional Expression (11) represented by

$$0 < f 2 B / \vert f 2 C \vert < 0.5 \qquad ( 11 )$$

is satisfied.

### Supplementary Note 29

A projection type display device comprising:
the projection optical system according to any one of Supplementary Notes 18 to 28.

### Supplementary Note 30

A projection optical system consisting of a first optical system and a second optical system along an optical path in order from an enlargement side to a reduction side,
in which the second optical system forms an intermediate image at a position conjugate to a reduction-side imaging plane between the first optical system and the second optical system, and the first optical system re-forms the intermediate image on an enlargement-side imaging plane,
a focus group that performs focus adjustment of an entire image plane in a case where a projection distance changes by moving along the optical axis and a back focus correction group that performs back focus adjustment by moving along the optical axis are disposed in the projection optical system, and
in a case where a distance on the optical axis from a lens surface closest to the enlargement side in the first optical system to a lens surface closest to the reduction side among lens surfaces in the focus group and the back focus correction group is represented by ZFBr,
a focal length of the projection optical system is represented by f, and
ZFBr and f are values at a wide-angle end in a case where the projection optical system is a variable magnification optical system,
Conditional Expression (16) represented by

$$5 < ZFBr / \vert f \vert < 20 \qquad ( 16 )$$

is satisfied.

### Supplementary Note 31

The projection optical system according to Supplementary Note 30,
in which in a case where a paraxial lateral magnification of the focus group is represented by βFF,
a combined paraxial lateral magnification of all of lenses closer to the reduction side than the focus group is represented by βFFr,
a paraxial lateral magnification of the back focus correction group is represented by βB
a combined paraxial lateral magnification of all of lenses closer to the reduction side than the back focus correction group is represented by βBr, and
βFF, βFFr, BB, and βBr are values at the wide-angle end in a case where the projection optical system is a variable magnification optical system,
Conditional Expressions (17) and (18) represented by

$$0.02 < ( 1 - β {FF}^{2} ) \times β {FFr}^{2} < 0.2 and \qquad ( 17 )$$

$$0.1 < \vert ( 1 - β {B}^{2} ) \times β B {r}^{2} \vert < 2 \qquad ( 18 )$$

are satisfied.

### Supplementary Note 32

The projection optical system according to Supplementary Note 30 or 31,
in which in a case where a paraxial lateral magnification of the back focus correction group is represented by BB,
a combined paraxial lateral magnification of all of lenses closer to the reduction side than the back focus correction group is represented by βBr,
a maximum image height on the reduction-side imaging plane is represented by Ymax,
an amount of change in an optical axis direction of a tangential image plane at a half angle of view of 50 degrees during movement of the back focus correction group by 0.1×Ymax in the optical axis direction is represented by ΔtB, and
βB, βBr, Ymax, and ΔtB are values at the wide-angle end in a case where the projection optical system is a variable magnification optical system,
Conditional Expression (19) represented by

$$0.7 < \vert ( 1 - β {B}^{2} ) \times β B {r}^{2} \vert / Δ tB < 1.4 \qquad ( 19 )$$

is satisfied.

### Supplementary Note 33

The projection optical system according to any one of Supplementary Notes 30 to 32,
in which in a case where a paraxial lateral magnification of the focus group is represented by βFF,
a combined paraxial lateral magnification of all of lenses closer to the reduction side than the focus group is represented by βFFr,
a maximum image height on the reduction-side imaging plane is represented by Ymax,
an amount of change in an optical axis direction of a tangential image plane at a half angle of view of 50 degrees during movement of the focus group by 0.1×Ymax in the optical axis direction is represented by ΔtFF, and
βFF, βFFr, Ymax, and ΔtFF are values at the wide-angle end in a case where the projection optical system is a variable magnification optical system,
Conditional Expression (20) represented by

$$0.1 < ( ( 1 - β {FF}^{2} ) \times β {FFr}^{2} ) / Δ tFF < 0.5 \qquad ( 20 )$$

is satisfied.

### Supplementary Note 34

The projection optical system according to any one of Supplementary Notes 30 to 33,
in which the focus group and the back focus correction group are movable independently of each other.

### Supplementary Note 35

The projection optical system according to any one of Supplementary Notes 30 to 34,
in which the projection optical system is a zoom lens including movable lens groups that move during changing magnification in the second optical system,
a group consisting of all of lenses closer to the enlargement side than the movable lens group closest to the enlargement side among the movable lens groups in the projection optical system is an enlargement-side stationary group, and
in a case where a longest air spacing between lens surfaces on the optical axis in the enlargement-side stationary group at the wide-angle end is represented by dAmax,
Conditional Expression (10) represented by

$$0.2 < dA max / Y max < 2.5 \qquad ( 10 )$$

is satisfied.

### Supplementary Note 36

The projection optical system according to any one of Supplementary Notes 30 to 35,
in which the projection optical system is a zoom lens,
in a case where one lens group is a group of which a spacing to an adjacent group in an optical axis direction changes during changing magnification in the second optical system,
the second optical system consists of a second A lens group, a second B lens group, a second C lens group, and a second D lens group along the optical path in order from the enlargement side to the reduction side, and
during changing magnification, the second A lens group and the second D lens group are fixed to the reduction-side imaging plane, and the second B lens group and the second C lens group move while changing a mutual spacing.

### Supplementary Note 37

The projection optical system according to Supplementary Note 36,
in which in a case where a focal length of the second B lens group is represented by f2B, and
a focal length of the second C lens group is represented by f2C,
Conditional Expression (11) represented by

$$0 < f 2 B / \vert f 2 C \vert < 0.5 \qquad ( 11 )$$

is satisfied.

### Supplementary Note 38

A projection type display device comprising:
the projection optical system according to any one of Supplementary Notes 30 to 37.

What is claimed is:

1. A projection optical system that projects an image on a reduction-side imaging plane onto an enlargement-side imaging plane,
wherein a half angle of view on an enlargement side is 50 degrees or more,
in a case where one lens component is one single lens or one cemented lens, the projection optical system includes a P lens component that is a lens component having a positive power and closest to the enlargement side among lens components in the projection optical system and an N lens component that is a lens component having a negative power and disposed adjacent to the enlargement side of the P lens component, and
in a case where a maximum image height on the reduction-side imaging plane is represented by Ymax,
a distance on an optical axis from a surface of an optical element having a power closest to the enlargement side in the projection optical system to a lens surface closest to the enlargement side in the P lens component is represented by Zp,
a curvature radius of the lens surface closest to the enlargement side in the P lens component is represented by Rpf,
a curvature radius of a lens surface closest to the reduction side in the N lens component is represented by Rnr,
a back focus of the projection optical system on the reduction side in terms of an air conversion distance is represented by Bf,
an image height on the reduction-side imaging plane of a ray having a half angle of view of 40 degrees on the enlargement side is represented by Y40,
an image height on the reduction-side imaging plane of a ray having a half angle of view of 50 degrees on the enlargement side is represented by Y50, and
Ymax, Zp, Bf, Y40, and Y50 are values at a wide-angle end in a case where the projection optical system is a variable magnification optical system,
Conditional Expressions (1), (2), (3), (4), and (5) represented by
$$1 < Zp / Y max < 4 , \qquad ( 1 )$$
$$0.2 < Rpf / Y max < 2.3 , \qquad ( 2 )$$
$$0.2 < Rnr / Y max < 5 , \qquad ( 3 )$$
$$2 < Bf / Y max < 8 , and \qquad ( 4 )$$
$$1.35 < Y 50 / Y 40 < 1.5 \qquad ( 5 )$$
are satisfied.

2. The projection optical system according to claim 1, consisting of a first optical system and a second optical system along an optical path in order from the enlargement side to the reduction side,
wherein the second optical system forms an intermediate image at a position conjugate to the reduction-side imaging plane between the first optical system and the second optical system, and the first optical system re-forms the intermediate image on the enlargement-side imaging plane.

3. The projection optical system according to claim 1,
wherein in a case where a spacing on the optical axis between the N lens component and the P lens component is represented by Dnp, and
Dnp is a value at the wide-angle end in a case where the projection optical system is a variable magnification optical system,
Conditional Expression (6) represented by
$$0 < Dnp / Y max < 0.1 \qquad ( 6 )$$
is satisfied.

4. The projection optical system according to claim 1,
wherein in a case where a curvature radius of a lens surface closest to the reduction side in the P lens component is represented by Rpr,
Conditional Expression (7) represented by
$$0 < ( Rpr + Rpf ) / ( Rpr - Rpf ) < 2 \qquad ( 7 )$$
is satisfied.

5. The projection optical system according to claim 1,
wherein in a case where a larger value among a maximum effective diameter of the lens surface closest to the enlargement side in the P lens component and a maximum effective diameter of the lens surface closest to the reduction side in the P lens component is represented by EDp,
Conditional Expression (8) represented by
$$0.5 < EDp / Y max < 2.5 \qquad ( 8 )$$
is satisfied.

6. The projection optical system according to claim 1,
wherein in a case where a curvature radius of a lens surface closest to the enlargement side in the N lens component is represented by Rnf,
Conditional Expression (9) represented by
$$- 1 < Rnr + Rnf ) / ( Rnr - Rnf ) < 0.5 \qquad ( 9 )$$
is satisfied.

7. The projection optical system according to claim 2,
wherein the projection optical system is a zoom lens including movable lens groups that move during changing magnification in the second optical system,
a group consisting of all of lenses closer to the enlargement side than the movable lens group closest to the enlargement side among the movable lens groups in the projection optical system is an enlargement-side stationary group, and
in a case where a longest air spacing between lens surfaces on the optical axis in the enlargement-side stationary group at the wide-angle end is represented by dAmax,
Conditional Expression (10) represented by
$$0.2 < dA max / Y max < 2.5 \qquad ( 10 )$$
is satisfied.

8. The projection optical system according to claim 2,
wherein the projection optical system is a zoom lens,
in a case where one lens group is a group of which a spacing to an adjacent group in an optical axis direction changes during changing magnification in the second optical system,
the second optical system consists of a second A lens group, a second B lens group, a second C lens group, and a second D lens group along the optical path in order from the enlargement side to the reduction side, and
during changing magnification, the second A lens group and the second D lens group are fixed to the reduction-side imaging plane, and the second B lens group and the second C lens group move while changing a mutual spacing.

9. The projection optical system according to claim 8,
wherein in a case where a focal length of the second B lens group is represented by f2B, and
a focal length of the second C lens group is represented by f2C,
Conditional Expression (11) represented by
$$0 < f 2 B / \vert f 2 C \vert < 0.5 \qquad ( 11 )$$
is satisfied.

10. The projection optical system according to claim 1,
wherein in a case where a larger value among a maximum effective diameter of an enlargement-side surface of a lens closest to the enlargement side in the projection optical system and a maximum effective diameter of a reduction-side surface of the lens closest to the enlargement side in the projection optical system is represented by EDL1, and
a specific gravity of the lens closest to the enlargement side in the projection optical system is represented by pL1,
Conditional Expression (12) represented by
$$0.5 < EDL 1 \times ρ L 1 / Y max < 10 \qquad ( 12 )$$
is satisfied.

11. The projection optical system according to claim 1,
wherein the P lens component is a single lens, and
a refractive index of the P lens component with respect to a d line is 1.65 or more.

12. The projection optical system according to claim 11,
wherein the N lens component is a single lens, and
a refractive index of the N lens component with respect to the d line is 1.65 or less.

13. The projection optical system according to claim 2,
wherein the first optical system includes an aspherical lens.

14. The projection optical system according to claim 13,
wherein the first optical system includes two aspherical lenses.

15. The projection optical system according to claim 13,
wherein a lens surface closest to the enlargement side in the first optical system is an aspherical surface that has a concave surface facing the enlargement side in a paraxial region and has an inflection point where an uneven shape changes halfway from the optical axis toward a peripheral portion.

16. The projection optical system according to claim 2,
wherein the reduction side is telecentric.

17. A projection type display device comprising:
the projection optical system according to claim 1.

18. A projection optical system consisting of a first optical system and a second optical system along an optical path in order from an enlargement side to a reduction side,
wherein the second optical system forms an intermediate image at a position conjugate to a reduction-side imaging plane between the first optical system and the second optical system, and the first optical system re-forms the intermediate image on an enlargement-side imaging plane,
a focus group that includes six or more lenses and performs focus adjustment of an entire image plane in a case where a projection distance changes by moving along the optical axis is disposed closest to the enlargement side in the projection optical system, and
all of lens spacings in the focus group are invariable during the focus adjustment.

19. The projection optical system according to claim 18,
wherein the focus group is disposed in the first optical system.

20. The projection optical system according to claim 18,
wherein a paraxial lateral magnification of the focus group is represented by βF,
a combined paraxial lateral magnification of all of lenses closer to the reduction side than the focus group is represented by βFr, and
βF and βFr are values at a wide-angle end in a case where the projection optical system is a variable magnification optical system,
Conditional Expression (13) represented by
$$0.02 < ( 1 - β {F}^{2} ) \times β {Fr}^{2} < 0.2 \qquad ( 13 )$$
is satisfied.

21. The projection optical system according to claim 18,
wherein a paraxial lateral magnification of the focus group is represented by βF,
a combined paraxial lateral magnification of all of lenses closer to the reduction side than the focus group is represented by βFr,
a maximum image height on the reduction-side imaging plane is represented by Ymax,
an amount of change in an optical axis direction of a tangential image plane at a half angle of view of 50 degrees during movement of the focus group by 0.1×Ymax in the optical axis direction is represented by ΔtF, and
βF, βFr, Ymax, and ΔtF are values at a wide-angle end in a case where the projection optical system is a variable magnification optical system,
Conditional Expression (14) represented by
$$0.1 < ( ( 1 β {F}^{2} ) \times β {Fr}^{2} ) / Δ tF < 0.5 \qquad ( 14 )$$
is satisfied.

22. The projection optical system according to claim 18,
wherein the focus group includes two or more positive lenses.

23. The projection optical system according to claim 18,
wherein a lens surface closest to the enlargement side in the focus group is an aspherical surface that has a concave surface facing the enlargement side in a paraxial region and has an inflection point where an uneven shape changes halfway from the optical axis toward a peripheral portion.

24. The projection optical system according to claim 18,
wherein among a first lens from the reduction side of the focus group and a second lens from the reduction side of the focus group, one lens is a positive lens and the other lens is a negative lens, and
in a case where a spacing on the optical axis between the first lens from the reduction side of the focus group and the second lens from the reduction side of the focus group is represented by dFr12,
a maximum image height on the reduction-side imaging plane is represented by Ymax, and
Ymax is a value at a wide-angle end in a case where the projection optical system is a variable magnification optical system,
Conditional Expression (15) represented by
$$0 \leq dFr 12 / Y max < 0.1 \qquad ( 15 )$$
is satisfied.

25. The projection optical system according to claim 18,
wherein a back focus correction group that performs back focus adjustment by moving along the optical axis is disposed.

26. The projection optical system according to claim 18,
wherein the projection optical system is a zoom lens including movable lens groups that move during changing magnification in the second optical system,
a group consisting of all of lenses closer to the enlargement side than the movable lens group closest to the enlargement side among the movable lens groups in the projection optical system is an enlargement-side stationary group, and
in a case where a longest air spacing between lens surfaces on the optical axis in the enlargement-side stationary group at a wide-angle end is represented by dAmax,
Conditional Expression (10) represented by
$$0.2 < dA max / Y max < 2.5 \qquad ( 10 )$$
is satisfied.

27. The projection optical system according to claim 18,
wherein the projection optical system is a zoom lens,
in a case where one lens group is a group of which a spacing to an adjacent group in an optical axis direction changes during changing magnification in the second optical system,
the second optical system consists of a second A lens group, a second B lens group, a second C lens group, and a second D lens group along the optical path in order from the enlargement side to the reduction side, and
during changing magnification, the second A lens group and the second D lens group are fixed to the reduction-side imaging plane, and the second B lens group and the second C lens group move while changing a mutual spacing.

28. The projection optical system according to claim 27,
wherein in a case where a focal length of the second B lens group is represented by f2B, and
a focal length of the second C lens group is represented by f2C,
Conditional Expression (11) represented by
$$0 < f 2 B / \vert f 2 C \vert < 0.5 \qquad ( 11 )$$
is satisfied.

29. A projection type display device comprising:
the projection optical system according to claim 18.

30. A projection optical system consisting of a first optical system and a second optical system along an optical path in order from an enlargement side to a reduction side,
wherein the second optical system forms an intermediate image at a position conjugate to a reduction-side imaging plane between the first optical system and the second optical system, and the first optical system re-forms the intermediate image on an enlargement-side imaging plane,
a focus group that performs focus adjustment of an entire image plane in a case where a projection distance changes by moving along the optical axis and a back focus correction group that performs back focus adjustment by moving along the optical axis are disposed in the projection optical system, and
in a case where a distance on the optical axis from a lens surface closest to the enlargement side in the first optical system to a lens surface closest to the reduction side among lens surfaces in the focus group and the back focus correction group is represented by ZFBr,
a focal length of the projection optical system is represented by f, and
ZFBr and f are values at a wide-angle end in a case where the projection optical system is a variable magnification optical system,
Conditional Expression (16) represented by
$$5 < ZFBr / \vert f \vert < 20 \qquad ( 16 )$$
is satisfied.

31. The projection optical system according to claim 30,
wherein in a case where a paraxial lateral magnification of the focus group is represented by βFF,
a combined paraxial lateral magnification of all of lenses closer to the reduction side than the focus group is represented by βFFr,
a paraxial lateral magnification of the back focus correction group is represented by βB,
a combined paraxial lateral magnification of all of lenses closer to the reduction side than the back focus correction group is represented by βBr, and
βFF, βFFr, βB, and βBr are values at the wide-angle end in a case where the projection optical system is a variable magnification optical system,
Conditional Expressions (17) and (18) represented by
$$0.02 < ( 1 β {FF}^{2} ) \times β {FFr}^{2} < 0.2 and \qquad ( 17 )$$
$$0.1 < \vert ( 1 β {B}^{2} ) \times β {Br}^{2} \vert < 2 \qquad ( 18 )$$
are satisfied.

32. The projection optical system according to claim 30,
wherein in a case where a paraxial lateral magnification of the back focus correction group is represented by βB,
a combined paraxial lateral magnification of all of lenses closer to the reduction side than the back focus correction group is represented by βBr,
a maximum image height on the reduction-side imaging plane is represented by Ymax, and
an amount of change in an optical axis direction of a tangential image plane at a half angle of view of 50 degrees during movement of the back focus correction group by 0.1×Ymax in the optical axis direction is represented by ΔtB, and
βB, βBr, Ymax, and ΔtB are values at the wide-angle end in a case where the projection optical system is a variable magnification optical system,
Conditional Expression (19) represented by
$$0.7 < \vert ( 1 β {B}^{2} ) \times β {Br}^{2} \vert / Δ tB < 1.4 \qquad ( 19 )$$
is satisfied.

33. The projection optical system according to claim 30,
wherein in a case where a paraxial lateral magnification of the focus group is represented by βFF,
a combined paraxial lateral magnification of all of lenses closer to the reduction side than the focus group is represented by βFFr,
a maximum image height on the reduction-side imaging plane is represented by Ymax, and
an amount of change in an optical axis direction of a tangential image plane at a half angle of view of 50 degrees during movement of the focus group by 0.1×Ymax in the optical axis direction is represented by ΔtFF, and
βFF, βFFr, Ymax, and ΔtFF are values at the wide-angle end in a case where the projection optical system is a variable magnification optical system,
Conditional Expression (20) represented by
$$0.1 < ( ( 1 β {FF}^{2} ) \times β {FFr}^{2} ) / Δ tFF < 0.5 \qquad ( 20 )$$
is satisfied.

34. The projection optical system according to claim 30,
wherein the focus group and the back focus correction group are movable independently of each other.

35. The projection optical system according to claim 30,
wherein the projection optical system is a zoom lens including movable lens groups that move during changing magnification in the second optical system,
a group consisting of all of lenses closer to the enlargement side than the movable lens group closest to the enlargement side among the movable lens groups in the projection optical system is an enlargement-side stationary group, and
in a case where a longest air spacing between lens surfaces on the optical axis in the enlargement-side stationary group at the wide-angle end is represented by dAmax,
Conditional Expression (10) represented by
$$0.2 < dA max / Y max < 2.5 \qquad ( 10 )$$
is satisfied.

36. The projection optical system according to claim 30,
wherein the projection optical system is a zoom lens,
in a case where one lens group is a group of which a spacing to an adjacent group in an optical axis direction changes during changing magnification in the second optical system,
the second optical system consists of a second A lens group, a second B lens group, a second C lens group, and a second D lens group along the optical path in order from the enlargement side to the reduction side, and
during changing magnification, the second A lens group and the second D lens group are fixed to the reduction-side imaging plane, and the second B lens group and the second C lens group move while changing a mutual spacing.

37. The projection optical system according to claim 36,
wherein in a case where a focal length of the second B lens group is represented by f2B, and
a focal length of the second C lens group is represented by f2C,
Conditional Expression (11) represented by
$$0 < f 2 B / \vert f 2 C \vert < 0.5 \qquad ( 11 )$$
is satisfied.

38. A projection type display device comprising:
the projection optical system according to claim 30.
